(19) United States
(12) Patent Application Publication
(10) Pub. No.: US 2018/0041839 A1
(43) Pub. Date: Feb. 8, 2018

(54) PIEZOELECTRIC SPEAKER

(71) Applicant: TOKIN Corporation, Sendai-shi, Miyagi (JP)

(72) Inventors: Yoshiyuki ABE, Sendai-shi, Miyagi (JP); Katsunori KUMASAKA, Sendai-shi, Miyagi (JP); Koichi SHUTA, Sendai-shi, Miyagi (JP); Osamu YAMAZAKl, Sendai-shi, Miyagi (JP); Noriaki IKEZAWA, Sendai-shi, Miyagi (JP); Masafumi KATSUNO, Sendai-shi, Miyagi (JP)

(21) Appl. No.: 15/548,271

(22) PCT Filed: Jan. 7, 2016
(86) PCT No.: PCT/JP2016/000049

§ 371 Date: Aug. 2, 2017

(30) Foreign Application Priority Data
Feb. 10, 2015 (JP) 2015-024041
May 26, 2015 (JP) 2015-106550

(51) Int. Cl. H04R 17/00; H04R 7/04; H04R 1/02; H04R 1/30

(52) U.S. Cl. CPC H04R 17/00; H04R 1/30; H04R 7/04; H04R 1/025

(57) ABSTRACT

A piezoelectric speaker (100, 200, . . . , or 500) includes a piezoelectric element (1), and a metal vibration part (2, 22, . . . , or 352) to which the piezoelectric element (1) is made to adhere through an adhesive part (3). The piezoelectric element (1) is a substantially rectangular plate. The metal vibration part (2, 22, . . . , or 352) includes a substantially rectangular plate-shaped part (2, 12a, 32a, . . . , 132a, or the like) vibrated by the piezoelectric element. A frequency of a natural vibration mode of the piezoelectric element (1) and a frequency of a natural vibration mode of the metal vibration part (2, 12a, 32a, . . . , 132a, or the like) are set to be different from each other.

### TECHNICAL FIELD

The present invention relates to piezoelectric speakers.

### BACKGROUND ART

There is a piezoelectric speaker including a piezoelectric element that vibrates by an input of an electrical signal, and a vibrating body to which the piezoelectric element is joined through a joining material.

For example, Patent Literature 1 discloses a piezoelectric speaker in which a joining material has a protruding portion that protrudes from an outer edge of a piezoelectric element when a vibrating body is seen in a planar view. At least a part of the protruding portion has a wavy shape. Hereby, frequency characteristics of a sound pressure can be flattened.

### CITATION LIST

### Patent Literature

Patent Literature 1

International Patent Publication No. WO2014/045645

### SUMMARY OF INVENTION

### Technical Problem

By the way, there is required a speaker that reproduces sound in a high frequency domain. However, the piezoelectric speaker disclosed in Patent Literature 1 cannot maintain good sound pressure characteristics in the high frequency domain in some cases.

The present invention provides a piezoelectric speaker that has good frequency characteristics of a sound pressure in the high frequency domain.

### Solution to Problem

A piezoelectric speaker according to the present invention includes: a piezoelectric element; and a metal vibration part to which the piezoelectric element is made to adhere through an adhesive part. In the piezoelectric speaker, the piezoelectric element is a substantially rectangular plate, the metal vibration part includes a substantially rectangular plate-shaped part that is vibrated by the piezoelectric element, and a frequency of a natural vibration mode of the piezoelectric element and a frequency of a natural vibration mode of the metal vibration part are set to be different from each other.

According to such a configuration, the piezoelectric speaker has good frequency characteristics of a sound pressure in a high frequency domain.

In addition, a relation between an area Ap of the piezoelectric element and an area Am of the rectangular plate-shaped part of the metal vibration part may satisfy 1.1≦Am/Ap≦10.

In addition, the adhesive part may be an elastic body.

In addition, a mechanical quality factor Qm of a vibrating body in which the piezoelectric element and the adhesive part are integrated with each other may satisfy Qm≦5.0.

In addition, the piezoelectric speaker further includes a case at which the metal vibration part is provided, the case having a sound emitting hole, and the sound emitting hole may have a horn shape.

In addition, the rectangular plate-shaped part may have a frequency adjusting hole.

In addition, the piezoelectric speaker further includes a case, and the metal vibration part may be made to adhere to the case through an elastic body.

A plurality of the piezoelectric elements may be made to adhere to the metal vibration part through the adhesive part.

Frequencies of natural vibration modes of the plurality of piezoelectric elements may be different from each other.

The metal vibration part may have one metal plate, and the plurality of piezoelectric elements may be made to adhere to the metal plate through the adhesive part.

The plurality of piezoelectric elements may be attached to the same surface of the metal plate.

The piezoelectric speaker may further include a case, and an electromagnetic speaker arranged inside the case.

The piezoelectric element may be arranged inside the case.

A mounting surface of the electromagnetic speaker and a mounting surface of the piezoelectric element may be the same surface of the case.

The piezoelectric element may be arranged outside the case, and the mounting surface of the electromagnetic speaker and the mounting surface of the piezoelectric element may be opposed surfaces of the case.

The metal vibration part may serve as a side plate or a back plate of the case.

The piezoelectric speaker further includes a cover that covers an opening of the case, and the metal vibration part may be fixed to the case or the cover through an elastic member.

The metal vibration part may include a metal plate having a thickness of 10 to 300 μm.

A piezoelectric speaker according to the other aspect of the present invention includes: a housing that has a front plate having a sound emitting hole, a back plate opposed to the front plate, and side plates between the front plate and the back plate; an electromagnetic speaker provided inside the housing; and a piezoelectric element attached to the housing.

The piezoelectric element is fixed to the housing through an adhesive part, and the adhesive part may be an elastic body.

The piezoelectric element may be arranged inside the housing.

A mounting surface of the electromagnetic speaker and a mounting surface of the piezoelectric element may be the same surface of the housing.

The piezoelectric element may be arranged outside the housing, and the mounting surface of the electromagnetic speaker and the mounting surface of the piezoelectric element may be opposed surfaces of the housing.

The mounting surface of the piezoelectric element may be a metal plate.

The metal plate may be fixed to the side plate, the front plate, or the back plate through an elastic member.

A thickness of the metal plate may be 10 to 300 μm.

The side plate, the front plate, or the back plate may serve as the mounting surface of the piezoelectric element, and may include a metal material and a resin material.

### Advantageous Effects of Invention

According to the present invention, there can be provided a piezoelectric speaker that has good frequency characteristics of a sound pressure in a high frequency domain.

### BRIEF DESCRIPTION OF DRAWINGS

FIG. 1 is a perspective view of a piezoelectric speaker according to an embodiment 1;

FIG. 2 is a cross-sectional view of the piezoelectric speaker according to the embodiment 1;

FIG. 3 is a bottom view of a main portion of the piezoelectric speaker according to the embodiment 1;

FIG. 4 is a graph showing a sound pressure with respect to a frequency;

FIG. 5 is a graph showing a sound pressure with respect to a frequency;

FIG. 6 is a bottom view of a main portion of a piezoelectric speaker according to an embodiment 2;

FIG. 7A is a cross-sectional view of a modified example 1 of the main portion of the piezoelectric speaker according to the embodiment 2;

FIG. 7B is a cross-sectional view of the modified example 1 of the main portion of the piezoelectric speaker according to the embodiment 2;

FIG. 7C is a cross-sectional view of the modified example 1 of the main portion of the piezoelectric speaker according to the embodiment 2;

FIG. 7D is a cross-sectional view of the modified example 1 of the main portion of the piezoelectric speaker according to the embodiment 2;

FIG. 8A is a cross-sectional view of a modified example 2 of the main portion of the piezoelectric speaker according to the embodiment 2;

FIG. 8B is a cross-sectional view of the modified example 2 of the main portion of the piezoelectric speaker according to the embodiment 2;

FIG. 8C is a cross-sectional view of the modified example 2 of the main portion of the piezoelectric speaker according to the embodiment 2;

FIG. 8D is a cross-sectional view of the modified example 2 of the main portion of the piezoelectric speaker according to the embodiment 2;

FIG. 9A is a cross-sectional view of a modified example 3 of the main portion of the piezoelectric speaker according to the embodiment 2;

FIG. 9B is a cross-sectional view of the modified example 3 of the main portion of the piezoelectric speaker according to the embodiment 2;

FIG. 9C is a cross-sectional view of the modified example 3 of the main portion of the piezoelectric speaker according to the embodiment 2;

FIG. 9D is a cross-sectional view of the modified example 3 of the main portion of the piezoelectric speaker according to the embodiment 2;

FIG. 10A is a cross-sectional view of a modified example 4 of the main portion of the piezoelectric speaker according to the embodiment 2;

FIG. 10B is a cross-sectional view of the modified example 4 of the main portion of the piezoelectric speaker according to the embodiment 2;

FIG. 10C is a cross-sectional view of the modified example 4 of the main portion of the piezoelectric speaker according to the embodiment 2;

FIG. 10D is a cross-sectional view of the modified example 4 of the main portion of the piezoelectric speaker according to the embodiment 2;

FIG. 11A is a cross-sectional view of a modified example 5 of the main portion of the piezoelectric speaker according to the embodiment 2;

FIG. 11B is a cross-sectional view of the modified example 5 of the main portion of the piezoelectric speaker according to the embodiment 2;

FIG. 12A is an exploded perspective view of a piezoelectric speaker according to an embodiment 3;

FIG. 12B is an exploded perspective view of a modified example of the piezoelectric speaker according to the embodiment 3;

FIG. 12C is an exploded perspective view of a modified example of the piezoelectric speaker according to the embodiment 3;

FIG. 13 is a graph showing a sound pressure with respect to a frequency of an Example of the piezoelectric speaker according to the embodiment 1;

FIG. 14 is a graph showing a sound pressure with respect to a frequency of a related speaker;

FIG. 15 is a bottom view of a related piezoelectric speaker;

FIG. 16 is a graph showing a sound pressure with respect to a frequency of the related piezoelectric speaker;

FIG. 17 is a cross-sectional view of a piezoelectric speaker according to an embodiment 4;

FIG. 18 is a bottom view of a main portion of the piezoelectric speaker according to the embodiment 4;

FIG. 19 is a graph showing a sound pressure with respect to a frequency of the piezoelectric speaker according to the embodiment 4;

FIG. 20 is a perspective view showing a configuration of a piezoelectric speaker according to an embodiment 5;

FIG. 21 is a cross-sectional view of a main portion of the piezoelectric speaker according to the embodiment 5;

FIG. 22 is a graph showing a sound pressure with respect to a frequency of the piezoelectric speaker according to the embodiment 5;

FIG. 23 is a cross-sectional view of a main portion of a piezoelectric speaker according to a modified example 6 of the embodiment 5;

FIG. 24 is a cross-sectional view of a main portion of a piezoelectric speaker according to a modified example 7 of the embodiment 5; and

FIG. 25 is a cross-sectional view of a main portion of a piezoelectric speaker according to a modified example 8 of the embodiment 5.

### DESCRIPTION OF EMBODIMENTS

### Embodiment 1

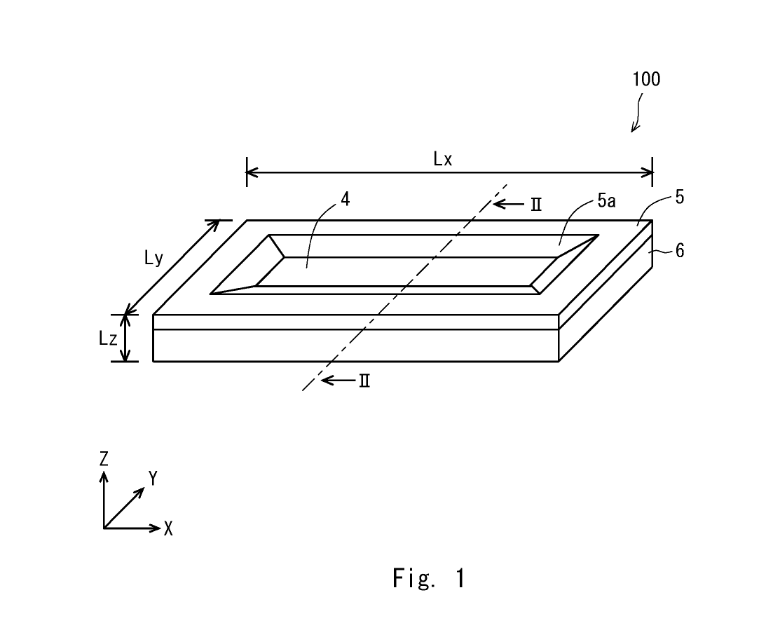

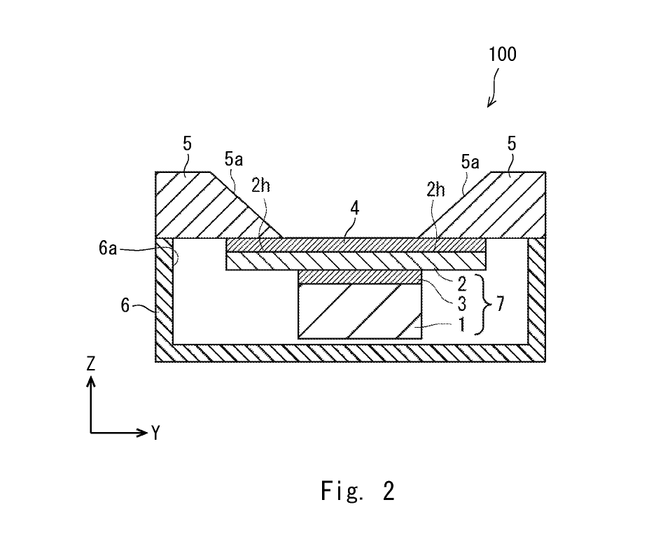

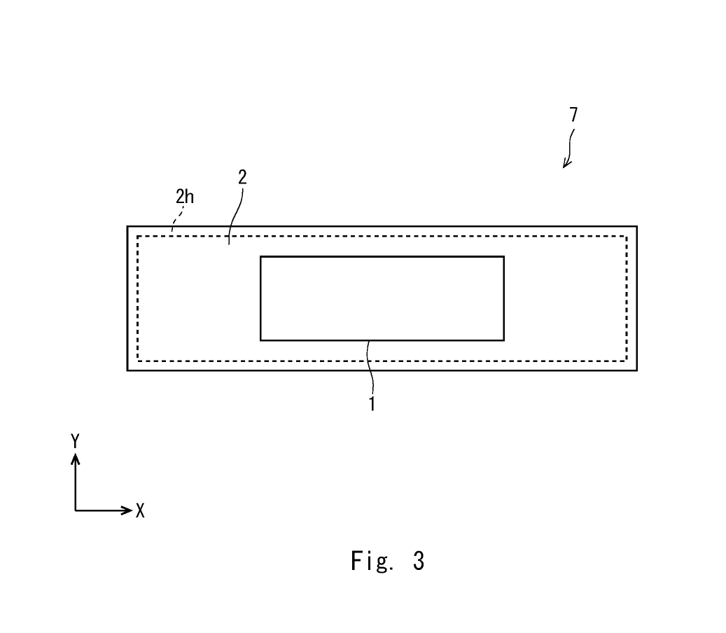

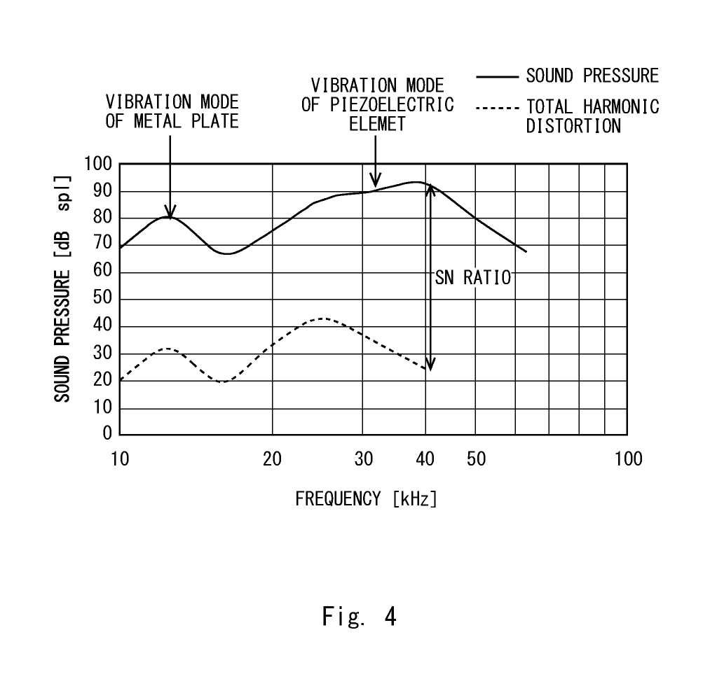

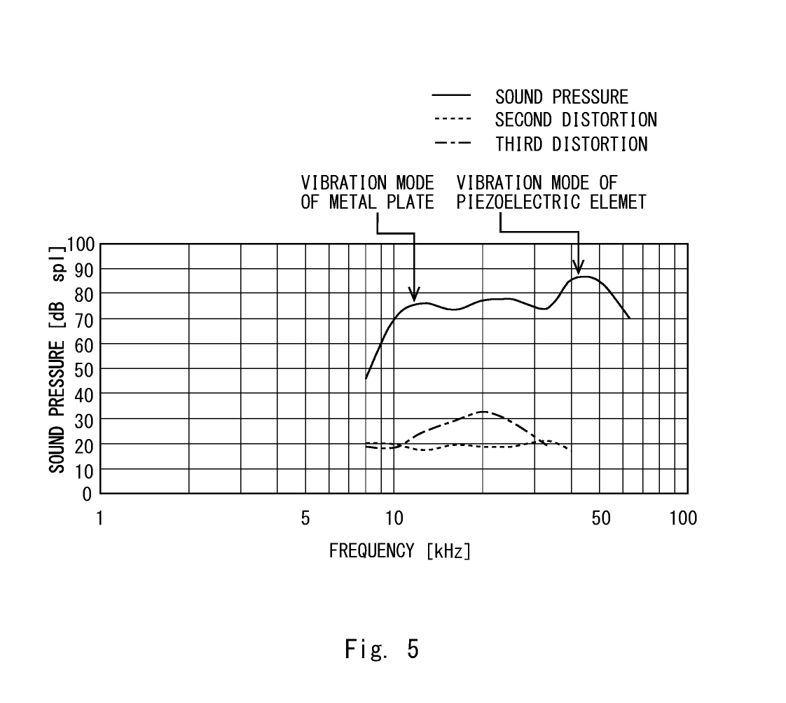

A piezoelectric speaker according to an embodiment 1 will be explained with reference to FIGS. 1 to 5. FIG. 1 is a perspective view of the piezoelectric speaker according to the embodiment 1. FIG. 2 is a cross-sectional view of the piezoelectric speaker according to the embodiment 1. FIG. 3 is a bottom view of a main portion of the piezoelectric speaker according to the embodiment 1. FIGS. 4 and 5 are graphs each showing a sound pressure with respect to a frequency.

As shown in FIGS. 1 to 3, a piezoelectric speaker 100 includes: a cover 5; a case 6; and a piezoelectric vibration unit 7.

The cover 5 is in a plate shape that has a sound emitting hole 5a in a center thereof. The sound emitting hole 5a penetrates through the cover 5, and a cross-sectional shape of the sound emitting hole 5a becomes larger as it goes toward an outside of the piezoelectric speaker 100. The sound emitting hole 5a, for example, has a horn shape. The case 6 is a rectangular parallelepiped housing that includes an opening 6a in one surface thereof. Note that the case 6 may be a frame-shaped body, and that the frame shape is a rectangular shape, for example, a substantially quadrangular shape, a substantially oblong shape, a substantially square shape, and a substantially trapezoidal shape. The opening 6a is closed by the cover 5. The case 6 equipped with the cover 5 has a width Lx, a depth Ly, and a height Lz. The width Lx is, for example, 10 to 20 mm, the depth Ly is, for example, 5 to 10 mm, and the height Lz is, for example, 2 to 10 mm.

The piezoelectric vibration unit 7 is made to adhere to an inner principal surface of the cover 5 through an adhesive part 4. Specifically, the piezoelectric vibration unit 7 is made to adhere to the inner principal surface of the cover 5 so as to close the sound emitting hole 5a.

The adhesive part 4 may just be a viscoelastic body, a viscous body, or a plate-shaped body or a band-shaped body having an adhesive property on both-side principal surfaces, while having a predetermined elastic coefficient. The adhesive part 4 may just be an elastic body. As the adhesive part 4, there is included, for example, a plate-shaped body or synthetic resin, such as silicone resin or epoxy resin that is formed using a double-sided tape. The adhesive part 4 preferably includes a material having such mechanical properties that vibrations of the piezoelectric vibration unit 7 are maintained to have magnitude required as a piezoelectric speaker. When the piezoelectric speaker 100 is seen from the cover 5 side, the adhesive part 4 may be a frame-shaped body not exposed from the sound emitting hole 5a. The adhesive part 4 is arranged so as to cover an outer edge 2h of a metal diaphragm 2. When the piezoelectric speaker 100 is seen from the cover 5 side, the outer edge 2h is covered with the cover 5. In addition, the adhesive part 4 preferably has the predetermined elastic coefficient since an apparent mechanical quality factor Qm21 (mentioned later) of the metal diaphragm 2 can be decreased.

The piezoelectric vibration unit 7 includes: a piezoelectric element 1; the metal diaphragm 2; and an adhesive part 3. The piezoelectric element 1 is made to adhere to the metal diaphragm 2 through the adhesive part 3. The piezoelectric element 1 is a vibrator that includes a substantially rectangular plate including a single ceramics plate. Note that the piezoelectric element 1 may be a stacked type, a bimorph type, and a unimorph type. The piezoelectric element 1 is electrically connected to an amplifier (illustration is omitted) etc., and vibrates by supply of an electrical signal for reproducing sound.

The metal diaphragm 2 is a substantially rectangular plate (it may be referred to as a rectangular plate-shaped part) that has a larger area than the piezoelectric element 1. The metal diaphragm 2, for example, includes steel and a copper alloy. As the steel and the copper alloy, there are included, for example, stainless steel, brass, phosphor bronze. The metal diaphragm 2 vibrates by vibrations of the piezoelectric element 1.

The adhesive part 3 includes the same type of material as the adhesive part 4. The metal diaphragm 2, for example, has a thickness of 0.5 to 1.5 mm. A size, a shape, a material, etc. of the metal diaphragm 2 are decided so that a natural vibration mode of the metal diaphragm 2 and a natural vibration mode of the piezoelectric element 1 may be set to have different frequencies. In other words, either one of the frequency (a resonance frequency) of the natural vibration mode of the metal diaphragm 2 and the frequency of the natural vibration mode of the piezoelectric element 1 is higher.

### (Area Ratio)

Subsequently, there will be explained a relation between an area of the piezoelectric element 1 and an area of the metal diaphragm 2.

A relational expression of an area Ap of the piezoelectric element 1 and an area Am of the metal diaphragm 2 is determined by using the following Formula 1.

1.1≦Am/Ap≦10 (Formula 1)

Hereby, the natural vibration mode of the metal diaphragm 2 and the natural vibration mode of the piezoelectric element 1 are set to have different frequencies more reliably. For example, as shown in FIG. 4, the natural vibration mode of the metal diaphragm 2 ranges from 10 to 20 kHz, the natural vibration mode of the piezoelectric element 1 is approximately 30 kHz, and thus they are set to have different frequencies.

Here, since the frequency of the natural vibration mode of the metal diaphragm 2 and the frequency of the natural vibration mode of the piezoelectric element 1 are different from each other, an amplitude when the piezoelectric vibration unit 7 vibrates the metal diaphragm 2 is almost the same as amplitudes corresponding to an elastic coefficient of the metal diaphragm 2 and an elastic coefficient of the piezoelectric element 1, respectively, or rarely exceeds the amplitudes corresponding to the elastic coefficient of the metal diaphragm 2 and the elastic coefficient of the piezoelectric element 1, respectively. In addition, even if the piezoelectric vibration unit 7 vibrates the metal diaphragm 2 almost to elastic limits of the metal diaphragm 2 and the piezoelectric element 1, a total harmonic distortion is hard to be large, and harsh sound is hard to occur.

An SN ratio SN1, i.e. a relational expression between a sound pressure SP1 and a total harmonic distortion THD1, is determined using the following Formula 2.

SN1=SP1−THD1 (Formula 2)

For example, as shown in FIG. 4, the SN ratio SN1 at 40 kHz is determined using Formula 2, and it is approximately 60 dB sq1.

Since the frequency of the natural vibration mode of the metal diaphragm 2 and the frequency of the natural vibration mode of the piezoelectric element 1 are different from each other, the total harmonic distortion can be suppressed from increasing, and thereby sound can be reproduced with a high SN ratio at a target frequency.

Further, a frequency band of the natural vibration mode of the metal diaphragm 2 is cut using a filter circuit, such as a high-pass filter, and thereby only a reproduction frequency range of the high SN ratio can be used. Note that in a case where the filter circuit, such as the high-pass filter, is used, a rigidity k2 of the metal diaphragm 2 is desirably 5 to 30, and a thickness t2 [mm] of the metal diaphragm 2 is desirably 0.05 to 0.3.

### Mechanical Quality Factor Qm of Metal Diaphragm

Subsequently, the mechanical quality factor Qm of a metal diaphragm will be explained.

Although the metal diaphragm 2 has a unique mechanical quality factor Qm20, the metal diaphragm 2 has adhered to the cover 5 through the adhesive part 4, and thus the apparent mechanical quality factor Qm21 of the metal diaphragm 2 is lower than the unique mechanical quality factor Qm20. The apparent mechanical quality factor Qm21 of the metal diaphragm 2 may be referred to as the mechanical quality factor Qm21 of a vibrating body in which the metal diaphragm 2 and the adhesive part 4 are integrated with each other. Materials and shapes of the piezoelectric element 1, the metal diaphragm 2, and the adhesive part 3 are desirably set so that the apparent mechanical quality factor Qm21 of the metal diaphragm 2 can satisfy the following Formula 3.

Qm21≦5.0 (Formula 3)

Formula 3 is preferably satisfied since a sound pressure characteristic curve is flattened.

In addition, the materials and the shapes of the piezoelectric element 1, the metal diaphragm 2, and the adhesive part 3 are desirably set so that the apparent mechanical quality factor Qm21 of the metal diaphragm 2 can satisfy Formula 3 and the following Formula 4.

Qm21≧0.5 (Formula 4)

In addition, since the piezoelectric element 1 has adhered to the metal diaphragm 2 through the adhesive part 3, a band of a frequency becomes wide. Here, the rigidity k2 of the metal diaphragm 2 is preferably 5 to 20, and the metal diaphragm 2 is desirably, for example, a plate including brass or phosphor bronze.

Since the apparent mechanical quality factor Qm21 of the metal diaphragm 2 is low, and the piezoelectric element 1 has adhered to the metal diaphragm 2 through the adhesive part 3, sound can be reproduced in a wide frequency band, and with a flat sound pressure characteristic curve. A sound pressure characteristic curve of one example of the piezoelectric speaker 100 was measured, and the sound pressure characteristic curve was shown in FIG. 5.

### (Comparative Example “Electromagnetic-Type Speaker”)

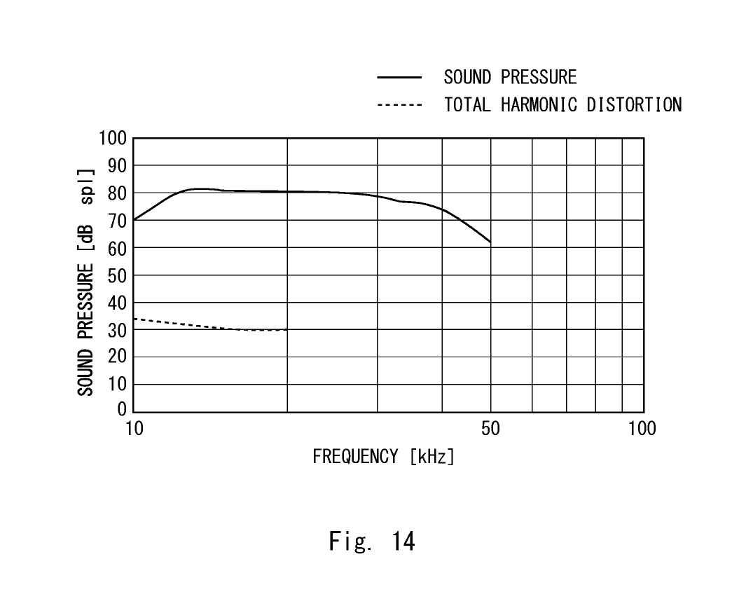

By the way, as shown in FIG. 14, a sound pressure and a total harmonic distortion with respect to a frequency were measured using one example of an electromagnetic-type speaker that vibrates a diaphragm by supplying an electrical signal to a voice coil to thereby generate a magnetic moment. An SN ratio SN2 of this one example was approximately 50 kHz, which is smaller compared with the SN ratio SN1 of one example of the piezoelectric speaker 100. The electromagnetic-type speaker reproduces sound having a high frequency of equal to or higher than 20 kHz using the voice coil. In that case, an electric power given by the rise of an impedance in the high frequency is converted into heat instead of an audio signal. Accordingly, the electromagnetic-type speaker is considered to be difficult to achieve a high sound pressure and a high SN ratio, compared with the piezoelectric speaker 100.

### (Comparative Example “Circular-Type Speaker”)

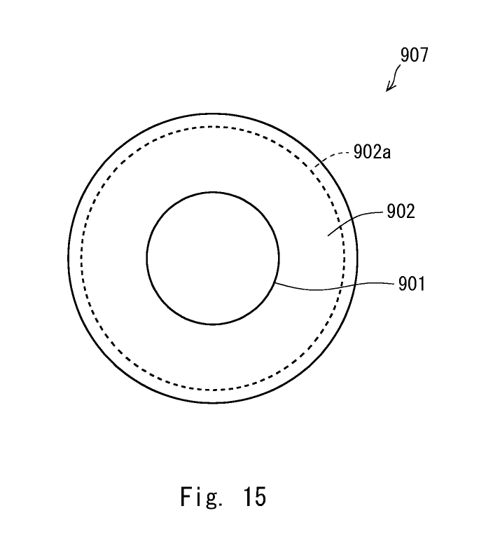

In addition, a sound pressure with respect to a frequency was measured using one example of a piezoelectric vibration unit 907 shown in FIG. 15. The piezoelectric vibration unit 907 includes a piezoelectric element 901 and a metal diaphragm 902.

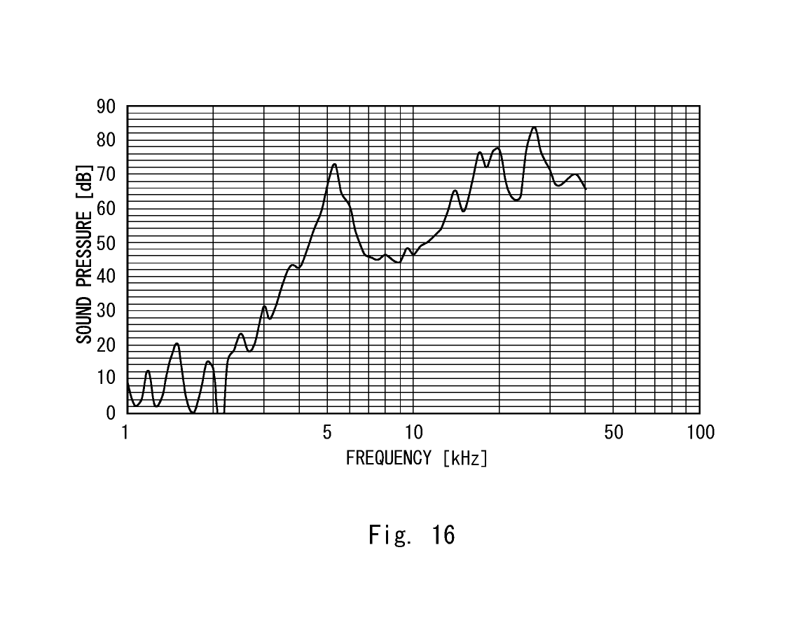

The piezoelectric element 901 has the same configuration as the piezoelectric element 1 (refer to FIG. 2) except for being a disc-shaped body. The metal diaphragm 902 has the same configuration as the metal diaphragm 2 (refer to FIG. 2) except for being a disc-shaped body. The piezoelectric vibration unit 907 is arranged inside a cover 905 (illustration is omitted) and the case 6 (refer to FIG. 2), and thereby a piezoelectric speaker 900 (illustration is omitted) is formed. Note that the cover 95 has the same configuration as the cover 5 except for having a sound emitting hole with a circular cross section. A piezoelectric element having a diameter of 20 mm and a thickness of 0.1 mm was used as the piezoelectric element 901, and a metal diaphragm including stainless steel having a diameter of 25 mm and a thickness of 0.1 mm was used as the metal diaphragm 902. As shown in FIG. 16, a mechanical quality factor Qm91 of a resonance frequency was equal to or more than 10. A sound pressure characteristic curve shown in FIG. 16 has less flat portions, i.e. has more portions with rise and fall, compared with the sound pressure curve shown in FIG. 5. That is, the piezoelectric speaker 900 is difficult to obtain a flat sound pressure characteristic curve compared with the piezoelectric speaker 100.

Here, a metal vibration part having a rectangular shape has more different natural vibration modes depending on directions of its principal surface compared with a metal vibration part having a circular shape. Note that the principal surface of the metal vibration part having the rectangular shape, for example, has a Y direction and an X direction as shown in FIG. 3. Therefore, the mechanical quality factor Qm is low. Further, a frequency can be easily adjusted by adjusting sizes of the metal vibration part and the piezoelectric element.

Hereinbefore, according to the piezoelectric speaker according to the embodiment 1, sound can be reproduced with good sound pressure characteristics in the high frequency domain. For example, reproduced sound has a high sound pressure and a high S/N ratio in a high frequency range, for example, from 20 to 70 kHz. In addition, the sound pressure characteristic curve is flat, and the frequency band of the piezoelectric speaker is wide.

### Embodiment 2

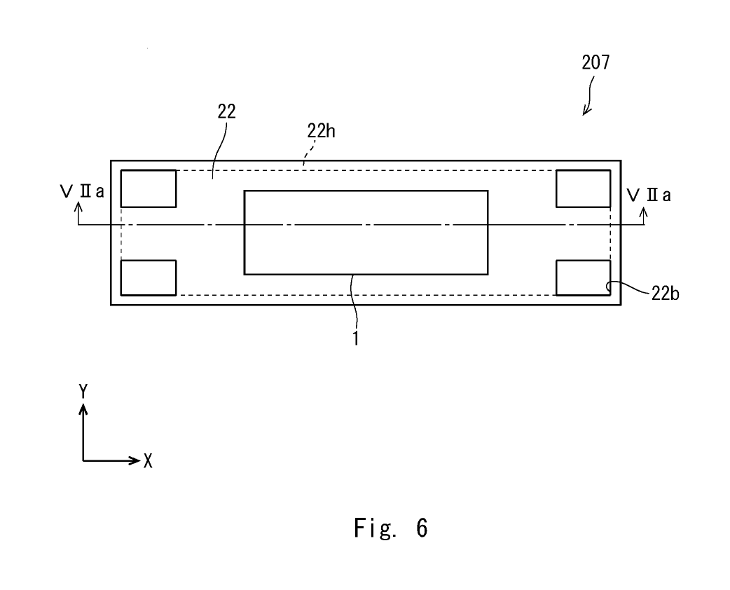

A piezoelectric speaker according to an embodiment 2 will be explained with reference to FIG. 6. FIG. 6 is a bottom view of a main portion of the piezoelectric speaker according to the embodiment 2. In the following explanation, explanation of the same configuration as the piezoelectric speaker according to the embodiment 1 is appropriately omitted, and different configurations are explained. Note that modified examples 1 to 5 of the piezoelectric speaker according to the embodiment 2, a piezoelectric speaker according to an embodiment 3, and modified examples thereof, which will be mentioned later, are similarly explained.

As shown in FIG. 6, a piezoelectric speaker 200 (illustration is omitted) has the same configuration as the piezoelectric speaker 100 except for the piezoelectric vibration unit 7. The piezoelectric speaker 200 includes a piezoelectric vibration unit 207. The piezoelectric vibration unit 207 has the same configuration as the piezoelectric vibration unit 7 except for the metal diaphragm 2. The piezoelectric vibration unit 207 includes a metal diaphragm 22. The metal diaphragm 22 has the same configuration as the metal diaphragm 2 except for having frequency adjusting holes 22b near four corners. An effective length of the metal diaphragm 22 and a width of the metal diaphragm 22 can be adjusted by changing the number and a size of the frequency adjusting holes 22b. Hereby, a frequency can be easily adjusted.

The above-described frequency adjusting method by the change in the number and the size of the frequency adjusting holes 22b can vibrate the metal diaphragm more easily, compared with a frequency adjusting method for adjusting the frequency by providing an additional member at the metal diaphragm. In addition, according to the above-described frequency adjusting method by the change in the number and the size of the frequency adjusting holes 22b, even if the piezoelectric speaker 200 is placed on an electromagnetic speaker, esp. a diaphragm thereof, the piezoelectric speaker 200 hardly cuts off reproduced sound by the electromagnetic speaker. In addition, the frequency adjusting hole 22b is formed by using etching processing or press working. Accordingly, the above-described frequency adjusting method by the number and the size of the frequency adjusting holes 22b can be carried out at low cost.

Hereinbefore, according to the above-described piezoelectric speaker according to the embodiment 2, sound can be reproduced with good sound pressure characteristics in a high frequency domain similarly to the piezoelectric speaker according to the embodiment 1. Further, since the metal diaphragm having the frequency adjusting hole is used, a frequency can be easily adjusted.

### Modified Example 1 of Piezoelectric Vibration Unit

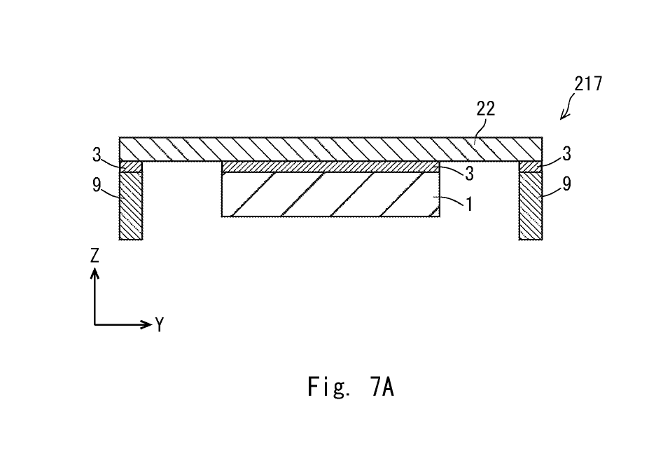

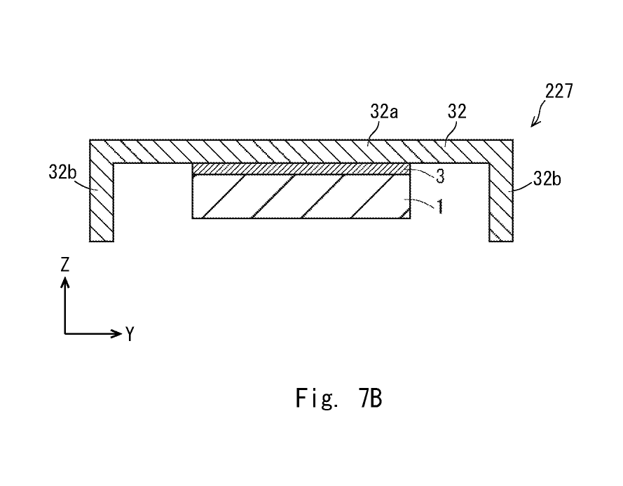

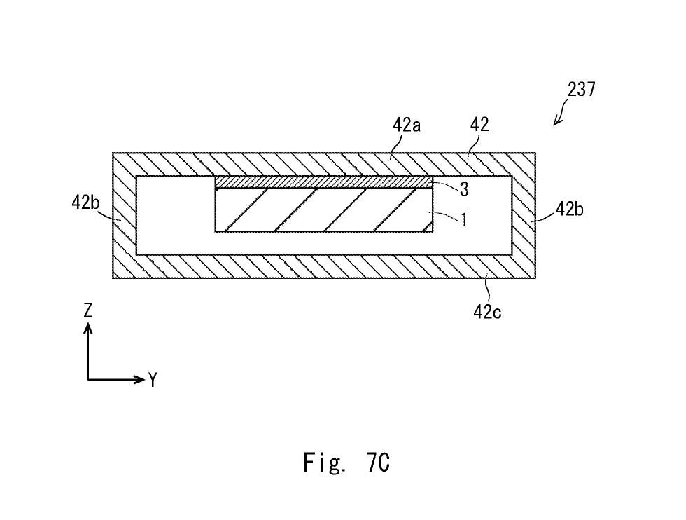

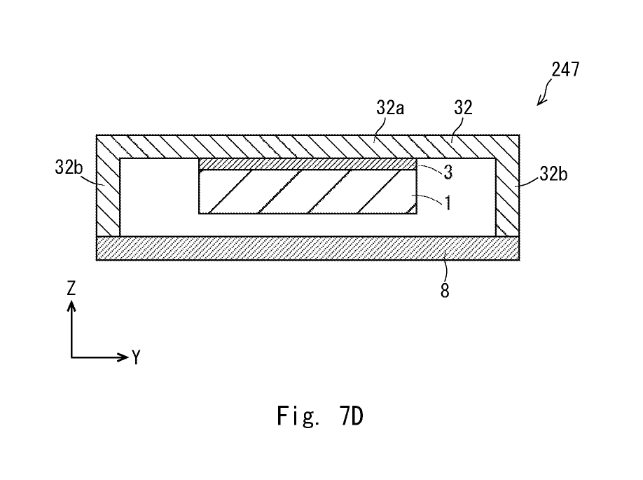

Next, there will be explained a modified example 1 of the piezoelectric vibration unit 207 of the piezoelectric speaker 200 according to the embodiment 2 with reference to FIGS. 6 and 7A to 7D. FIGS. 7A to 7D are cross-sectional views of the modified example 1 of the main portion of the piezoelectric speaker according to the embodiment 2.

As shown in FIGS. 6 and 7A, there is a piezoelectric vibration unit 217 that is a modified example of the piezoelectric vibration unit 207. The piezoelectric vibration unit 217 has the same configuration as the piezoelectric vibration unit 207 except for having holders 9. The piezoelectric vibration unit 217 includes the holders 9, and ends of the metal diaphragm 22 have adhered to the holders 9 through the adhesive parts 3. In addition, the metal diaphragm 22 is held by the holders 9. The holder 9 is a wall body that extends from a bottom of the case 6 (refer to FIG. 2) toward the metal diaphragm 22. The holders 9 are arranged to cover the surroundings of the piezoelectric element 1 so that neither water nor foreign substances may attach to the piezoelectric element 1. Since the piezoelectric vibration unit 217 has the holders 9, it suppresses water and foreign substances having entered from the frequency adjusting hole 22b etc. from coming into contact with the piezoelectric element 1.

Meanwhile, as shown in FIG. 7B, there is a piezoelectric vibration unit 227 that is a modified example of the piezoelectric vibration unit 207. The piezoelectric vibration unit 227 has a metal diaphragm 32 having the same shape as a shape in which the metal diaphragm 22 and the holders 9 are integrated with each other.

Since in the piezoelectric vibration unit 227, a body 32a (it may be referred to as a substantially rectangular plate-shaped part) and holding parts 32b are integrated with each other, the piezoelectric vibration unit 227 further suppresses the water and the foreign substances having entered from the frequency adjusting hole 22b etc. from coming into contact with the piezoelectric element 1. In addition, since in the piezoelectric vibration unit 227, the body 32a and the holding parts 32b are integrated with each other, the piezoelectric vibration unit 227 can be manufactured at low cost.

Further, as shown in FIG. 7C, there is a piezoelectric vibration unit 237 that is a modified example of the piezoelectric vibration unit 207. The piezoelectric vibration unit 237 has a metal vibration part 42. The metal vibration part 42 has the same configuration as the metal diaphragm 32 (refer to FIG. 7B) except for having a bottom 42c. The metal vibration part 42 includes: a body 42a; holding parts 42b; and the bottom 42c. The body 42a has the same configuration as the body 32a, and the holding part 42b has the same configuration as the holding part 32b. The bottom 42c is integrated with the holding parts 42b, and is a plate-shaped body that is opposed to the body 42a.

Since in the piezoelectric vibration unit 237, the body 42a, the holding parts 42b, and the bottom 42c are integrated with each other, the piezoelectric vibration unit 237 further suppresses the water and the foreign substances having entered from the frequency adjusting hole 22b etc. from coming into contact with the piezoelectric element 1. In addition, since in the piezoelectric vibration unit 237, the body 42a, the holding parts 42b, and the bottom 42c are integrated with each other, the piezoelectric vibration unit 237 has a high rigidity.

Further, as shown in FIG. 7D, there is a piezoelectric vibration unit 247 that is a modified example of the piezoelectric vibration unit 207. The piezoelectric vibration unit 247 has the same configuration as the piezoelectric vibration unit 227 (refer to FIG. 7B) except for including a bottom plate 8. The piezoelectric vibration unit 247 includes the bottom plate 8. The bottom plate 8 is provided under lower ends of the holding parts 32b, and is a plate-shaped body that is opposed to the body 32a. An outer edge of the bottom plate 8 and the lower ends of the holding parts 32b may be installed so as to abut against each other. Since the piezoelectric vibration unit 247 has the bottom plate 8, it further suppresses the water and the foreign substances having entered from the frequency adjusting hole 22b etc. from coming into contact with the piezoelectric element 1, compared with the piezoelectric vibration unit 227. In addition, since the piezoelectric vibration unit 247 has the bottom plate 8, it has a higher rigidity compared with the piezoelectric vibration unit 227 (refer to FIG. 7B).

### Modified Example 2 of Piezoelectric Vibration Unit

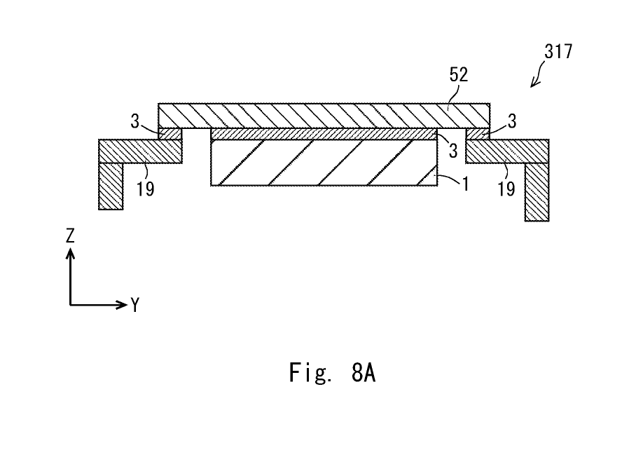

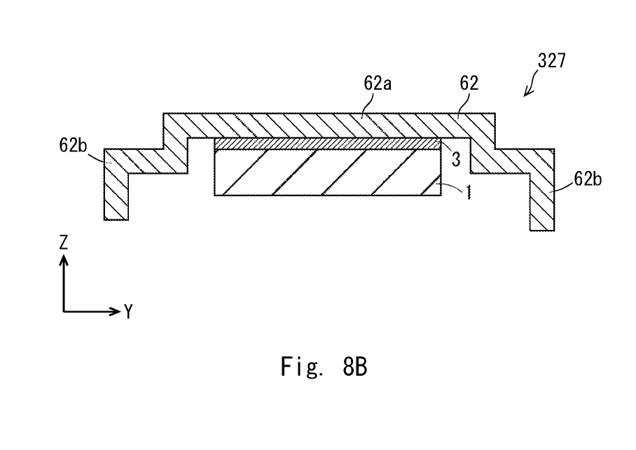

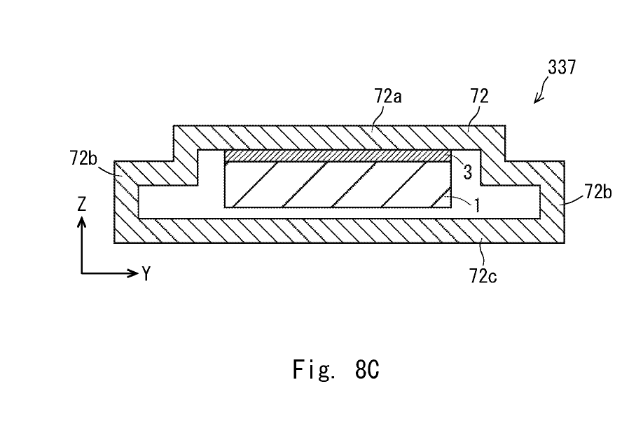

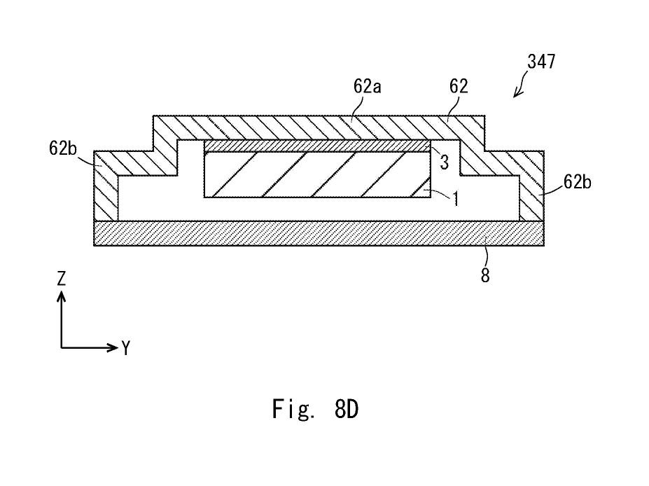

Next, there will be explained a modified example 2 of the piezoelectric vibration unit 207 of the piezoelectric speaker 200 according to the embodiment 2 with reference to FIGS. 8A to 8D. FIGS. 8A to 8D are cross-sectional views of the modified example 2 of the main portion of the piezoelectric speaker according to the embodiment 2.

As shown in FIG. 8A, there is a piezoelectric vibration unit 317 that is a modified example of the piezoelectric vibration unit 207. The piezoelectric vibration unit 317 has the same configuration as the piezoelectric vibration unit 217 except for a metal diaphragm 52 and stepped holders 19. The piezoelectric vibration unit 317 includes the metal diaphragm 52 and the stepped holders 19, and the metal diaphragm 52 has adhered to the stepped holders 19 through the adhesive parts 3. In addition, the metal diaphragm 52 is held by the stepped holders 19. The stepped holder 19 is a wall body that extends from the bottom of the case 6 (refer to FIG. 2) toward the metal diaphragm 52, and stepwisely bends in the middle. The stepped holders 19 are arranged to cover the surroundings of the piezoelectric element 1 so that neither water nor foreign substances may attach to the piezoelectric element 1.

Since the piezoelectric vibration unit 317 has the stepped holders 19, it suppresses water and foreign substances having entered from the frequency adjusting hole 22b etc. from coming into contact with the piezoelectric element 1. In addition, since the piezoelectric vibration unit 317 has the stepped holders 19, it has a higher pressure resistance compared with the piezoelectric vibration unit 217.

Meanwhile, as shown in FIG. 8B, there is a piezoelectric vibration unit 327 that is a modified example of the piezoelectric vibration unit 207. The piezoelectric vibration unit 327 has a metal diaphragm 62 having the same shape as a shape in which the metal diaphragm 52 and the stepped holders 19 are integrated with each other, similarly to the piezoelectric vibration unit 227 (refer to FIG. 7B).

Since in the piezoelectric vibration unit 327, a body 62a (it may be referred to as a substantially rectangular plate-shaped part) and holding parts 62b are integrated with each other, the piezoelectric vibration unit 327 further suppresses the water and the foreign substances having entered from the frequency adjusting hole 22b etc. from coming into contact with the piezoelectric element 1, compared with the piezoelectric vibration unit 317 (refer to FIG. 8A). In addition, since in the piezoelectric vibration unit 327, the body 62a and the holding parts 62b are integrated with each other, the piezoelectric vibration unit 327 can be manufactured at lower cost compared with the piezoelectric vibration unit 317.

In addition, as shown in FIG. 8C, there is a piezoelectric vibration unit 337 that is a modified example of the piezoelectric vibration unit 207. The piezoelectric vibration unit 337 has a metal vibration part 72. The metal vibration part 72 has the same configuration as the metal diaphragm 62 (refer to FIG. 8B) except for having a bottom 72c. The metal vibration part 72 includes: a body 72a; holding parts 72b; and the bottom 72c. The body 72a has the same configuration as the body 62a, and the holding part 72b has the same configuration as the holding part 62b. The bottom 72c is integrated with the holding parts 72b, and is a plate-shaped body that is opposed to the body 72a.

Since in the piezoelectric vibration unit 337, the body 72a, the holding parts 72b, and the bottom 72c are integrated with each other, the piezoelectric vibration unit 337 further suppresses the water and the foreign substances having entered from the frequency adjusting hole 22b etc. from coming into contact with the piezoelectric element 1, compared with the piezoelectric vibration unit 317. In addition, since in the piezoelectric vibration unit 337, the body 72a, the holding parts 72b, and the bottom 72c are integrated with each other, the piezoelectric vibration unit 337 has a higher rigidity compared with the piezoelectric vibration unit 317.

In addition, as shown in FIG. 8D, there is a piezoelectric vibration unit 347 that is a modified example of the piezoelectric vibration unit 207. The piezoelectric vibration unit 347 has the same configuration as a unit in which the bottom plate 8 is added to the piezoelectric vibration unit 327 (refer to FIG. 8B).

Since the piezoelectric vibration unit 347 has the bottom plate 8, it further suppresses the water and the foreign substances having entered from the frequency adjusting hole 22b etc. from coming into contact with the piezoelectric element 1, compared with the piezoelectric vibration unit 327 (refer to FIG. 8B). In addition, since the piezoelectric vibration unit 247 has the bottom plate 8, it has a higher rigidity compared with the piezoelectric vibration unit 327.

### Modified Example 3 of Piezoelectric Vibration Unit

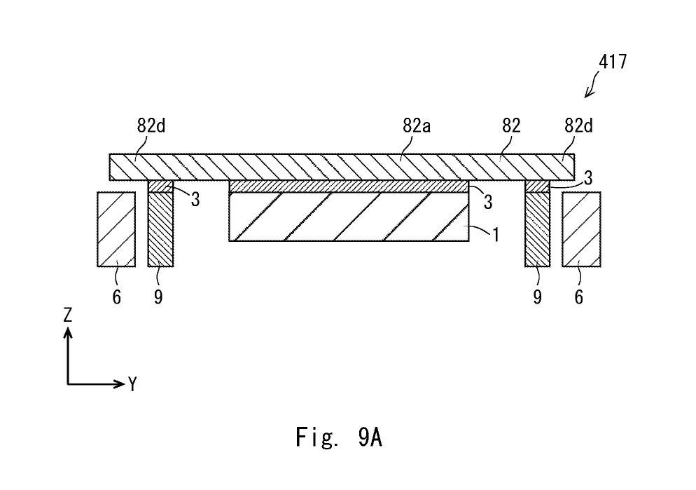

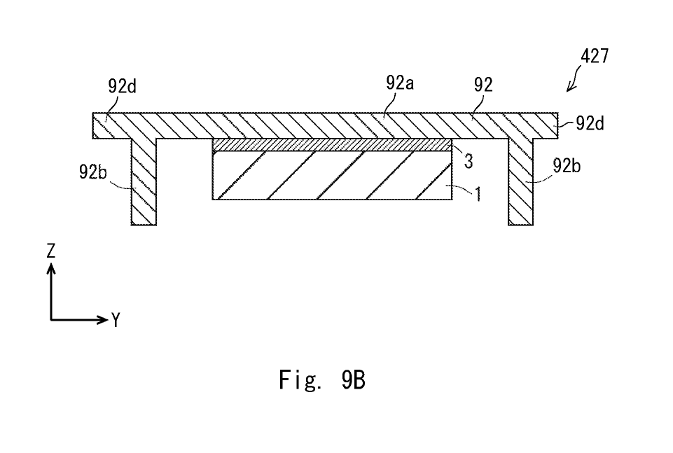

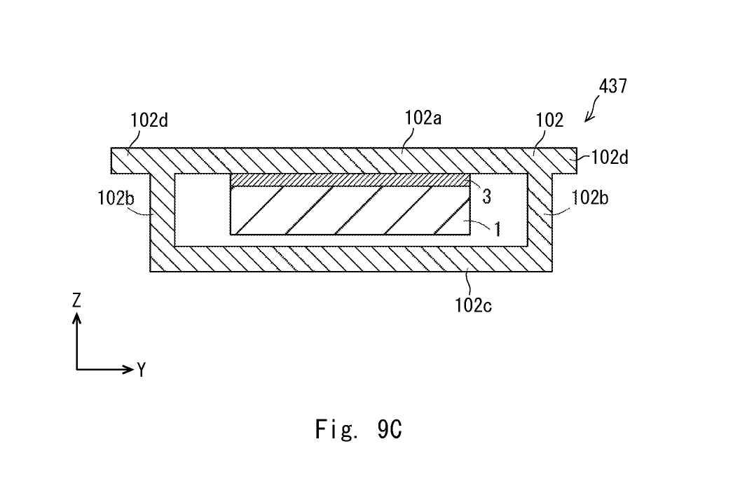

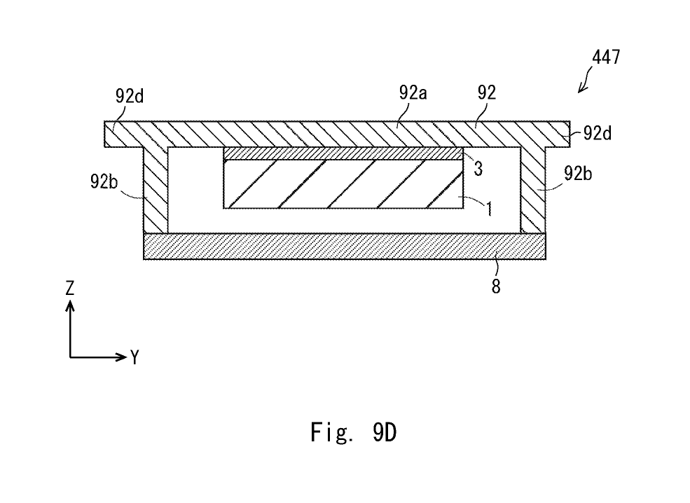

Next, there will be explained a modified example 3 of the piezoelectric vibration unit 207 of the piezoelectric speaker 200 according to the embodiment 2 with reference to FIGS. 9A to 9D. FIGS. 9A to 9D are cross-sectional views of the modified example 3 of the main portion of the piezoelectric speaker according to the embodiment 2.

As shown in FIG. 9A, there is a piezoelectric vibration unit 417 that is a modified example of the piezoelectric vibration unit 207. The piezoelectric vibration unit 417 has the same configuration as the piezoelectric vibration unit 217 (refer to FIG. 7A) except for having a metal diaphragm 82. The piezoelectric vibration unit 417 includes the metal diaphragm 82, and the metal diaphragm 82 includes a body 82a, and gripped portions 82d that extend from ends of the body 82a. The body 82a has the same configuration as the metal diaphragm 22, and the ends of the body 82a have adhered to the holders 9 through the adhesive parts 3. The gripped portions 82d extend toward side walls of the case 6. By the way, the piezoelectric vibration unit 417 is mounted in the case 6, and thereby the piezoelectric speaker 200 can be assembled. Here, since the gripped portion 82d has a shape that extends from the end of the body 82a, it is easy to grip. In addition, the shape of the gripped portion 82d may be changed as needed, in order to make the piezoelectric vibration unit 417 easy to mount in the case 6.

Since the piezoelectric vibration unit 417 has the metal diaphragm 82 and the holders 9, it suppresses water and foreign substances having entered from the frequency adjusting hole 22b etc. from coming into contact with the piezoelectric element 1. In addition, since the piezoelectric vibration unit 417 has the metal diaphragm 82, it can be mounted more easily compared with the piezoelectric vibration unit 217 (refer to FIG. 7A).

Meanwhile, as shown in FIG. 9B, there is a piezoelectric vibration unit 427 that is a modified example of the piezoelectric vibration unit 207. The piezoelectric vibration unit 427 has a metal diaphragm 92 having the same shape as a shape in which the metal diaphragm 82 and the holders 9 are integrated with each other.

Since in the piezoelectric vibration unit 427, a body 92a, holding parts 92b, and gripped portions 92d are integrated with each other, the piezoelectric vibration unit 427 further suppresses water and foreign substances having entered from the frequency adjusting hole 22b etc. from coming into contact with the piezoelectric element 1, compared with the piezoelectric vibration unit 417 (refer to FIG. 9A). In addition, since in the piezoelectric vibration unit 427, the body 92a, the holding parts 92b, and the gripped portions 92d are integrated with each other, the piezoelectric vibration unit 427 can be manufactured at lower cost compared with the piezoelectric vibration unit 417 (refer to FIG. 9A).

In addition, as shown in FIG. 9C, there is a piezoelectric vibration unit 437 that is a modified example of the piezoelectric vibration unit 207. The piezoelectric vibration unit 437 has a metal vibration part 102. The metal vibration part 102 has the same configuration as the metal diaphragm 92 (refer to FIG. 9B) except for having a bottom 102c. The metal vibration part 102 includes: a body 102a; holding parts 102b; and the bottom 102c. The body 102a has the same configuration as the body 92a, and the holding part 102b has the same configuration as the holding part 92b. The bottom 102c is integrated with the holding parts 102b, and is a plate-shaped body that is opposed to the body 102a.

Since in the piezoelectric vibration unit 437, the body 102a, the holding parts 102b, and the bottom 102c are integrated with each other, the piezoelectric vibration unit 437 further suppresses the water and the foreign substances having entered from the frequency adjusting hole 22b etc. from coming into contact with the piezoelectric element 1, compared with the piezoelectric vibration unit 417. In addition, since in the piezoelectric vibration unit 437, the body 102a, the holding parts 102b, and the bottom 102c are integrated with each other, the piezoelectric vibration unit 437 has a higher rigidity compared with the piezoelectric vibration unit 417.

In addition, as shown in FIG. 9D, there is a piezoelectric vibration unit 447 that is a modified example of the piezoelectric vibration unit 207. The piezoelectric vibration unit 447 has the same configuration as a unit in which the bottom plate 8 is added to the piezoelectric vibration unit 427 (refer to FIG. 9B).

Since the piezoelectric vibration unit 447 has the bottom plate 8, similarly to the piezoelectric vibration unit 247 (refer to FIG. 7D), the piezoelectric vibration unit 447 further suppresses the water and the foreign substances having entered from the frequency adjusting hole 22b etc. from coming into contact with the piezoelectric element 1, compared with the piezoelectric vibration unit 427 (refer to FIG. 9D). In addition, since the piezoelectric vibration unit 447 has the bottom plate 8, it has a higher rigidity compared with the piezoelectric vibration unit 427.

### Modified Example 4 of Piezoelectric Vibration Unit

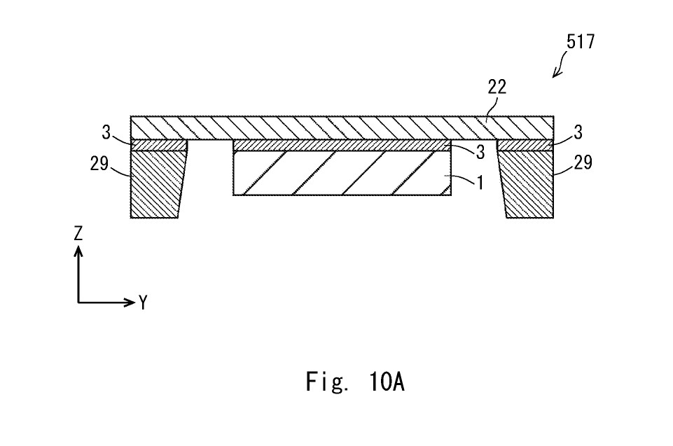

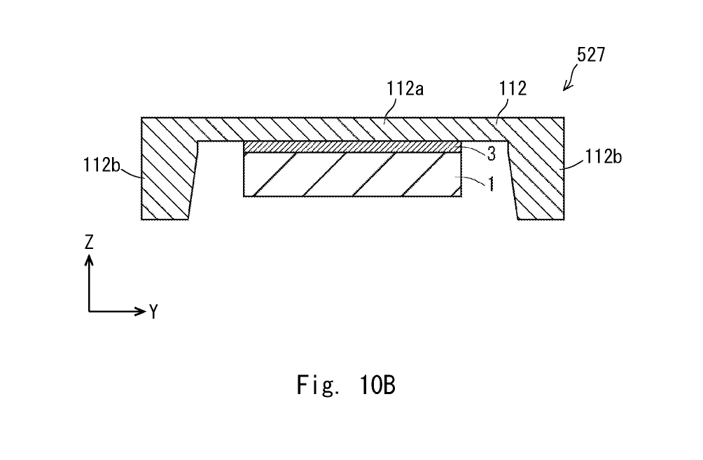

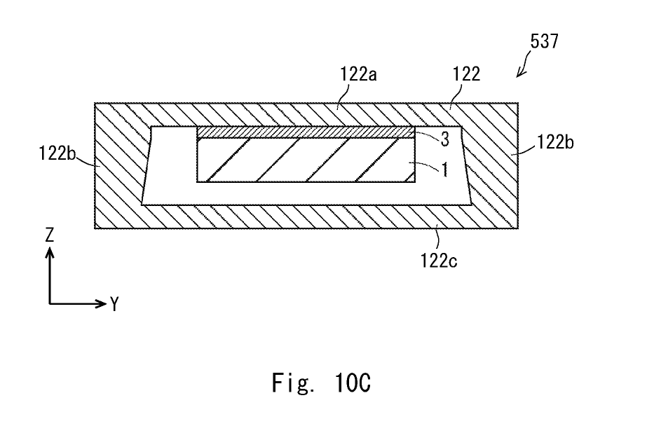

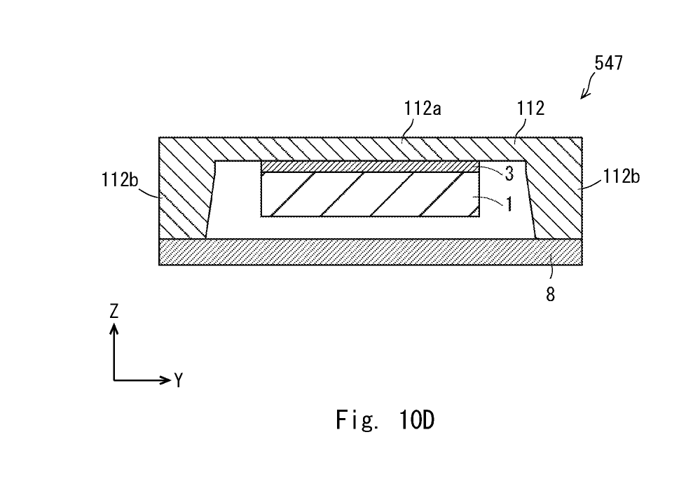

Next, there will be explained a modified example 4 of the piezoelectric vibration unit 207 of the piezoelectric speaker 200 according to the embodiment 2 with reference to FIGS. 10A to 10D. FIGS. 10A to 10D are cross-sectional views of the modified example 4 of the main portion of the piezoelectric speaker according to the embodiment 2.

As shown in FIG. 10A, there is a piezoelectric vibration unit 517 that is a modified example of the piezoelectric vibration unit 207. The piezoelectric vibration unit 517 has the same configuration as the piezoelectric vibration unit 217 except for having tapered holders 29 instead of the holders 9. The piezoelectric vibration unit 517 includes the tapered holders 29, and ends of the metal diaphragm 22 have adhered to the tapered holders 29 through the adhesive parts 3. In addition, the metal diaphragm 22 is held by the tapered holders 29. The tapered holder 29 is a wall body that extends from the bottom of the case 6 (refer to FIG. 2) toward the metal diaphragm 22. The tapered holder 29 has a tapered shape, which is a shape whose cross-sectional area becomes larger toward the metal diaphragm 22 from the bottom of the case 6. More specifically, the tapered shape inclines on the piezoelectric element 1 side. The holders 9 are arranged to cover the surroundings of the piezoelectric element 1 so that neither water nor foreign substances may attach to the piezoelectric element 1.

Since the piezoelectric vibration unit 517 has the tapered holders 29, it suppresses water and foreign substances having entered from the frequency adjusting hole 22b etc. from coming into contact with the piezoelectric element 1.

Meanwhile, as shown in FIG. 10B, there is a piezoelectric vibration unit 527 that is a modified example of the piezoelectric vibration unit 207. The piezoelectric vibration unit 527 has a metal diaphragm 112 having the same shape as a shape in which the metal diaphragm 22 and the tapered holders 29 are integrated with each other, similarly to the piezoelectric vibration unit 227 (refer to FIG. 7B).

Since in the piezoelectric vibration unit 527, a body 112a and holding parts 12b are integrated with each other, the piezoelectric vibration unit 527 further suppresses the water and the foreign substances having entered from the frequency adjusting hole 22b etc. from coming into contact with the piezoelectric element 1, compared with the piezoelectric vibration unit 517 (refer to FIG. 10A). In addition, since in the piezoelectric vibration unit 527, the body 112a and the holding parts 12b are integrated with each other, it can be manufactured at lower cost compared with the piezoelectric vibration unit 517.

In addition, as shown in FIG. 10C, there is a piezoelectric vibration unit 537 that is a modified example of the piezoelectric vibration unit 207.

The piezoelectric vibration unit 537 has a metal vibration part 122. The metal vibration part 122 has the same configuration as the metal diaphragm 112 (refer to FIG. 10B) except for having a bottom 122c. The metal vibration part 122 includes: a body 122a; holding parts 122b; and the bottom 122c. The body 122a has the same configuration as the body 112a, and the holding part 122b has the same configuration as the holding part 112b. The bottom 122c is integrated with the holding parts 122b, and is a plate-shaped body that is opposed to the body 122a.

Since in the piezoelectric vibration unit 537, the body 12a, the holding parts 122b, and the bottom 122c are integrated with each other, the piezoelectric vibration unit 537 further suppresses the water and the foreign substances having entered from the frequency adjusting hole 22b etc. from coming into contact with the piezoelectric element 1, compared with the piezoelectric vibration unit 517 (refer to FIG. 10A). In addition, since in the piezoelectric vibration unit 537, the body 102a, the holding parts 102b, and the bottom 102c are integrated with each other, the piezoelectric vibration unit 537 has a higher rigidity compared with the piezoelectric vibration unit 517.

In addition, as shown in FIG. 10D, there is a piezoelectric vibration unit 547 that is a modified example of the piezoelectric vibration unit 207. The piezoelectric vibration unit 547 has the same configuration as a unit in which the bottom plate 8 is added to the piezoelectric vibration unit 527 (refer to FIG. 10B).

Since the piezoelectric vibration unit 547 has the bottom plate 8, similarly to the piezoelectric vibration unit 247 (refer to FIG. 7D), the piezoelectric vibration unit 547 further suppresses the water and the foreign substances having entered from the frequency adjusting hole 22b etc. from coming into contact with the piezoelectric element 1, compared with the piezoelectric vibration unit 527 (refer to FIG. 10D). In addition, since the piezoelectric vibration unit 547 has the bottom plate 8, it has a higher rigidity compared with the piezoelectric vibration unit 527.

### Modified Example 5 of Piezoelectric Vibration Unit

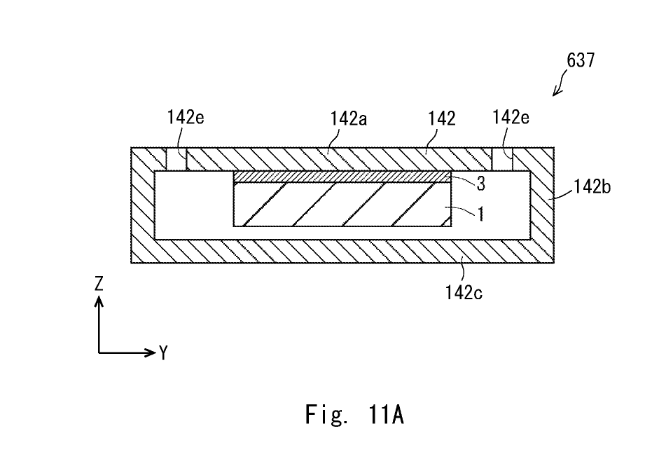

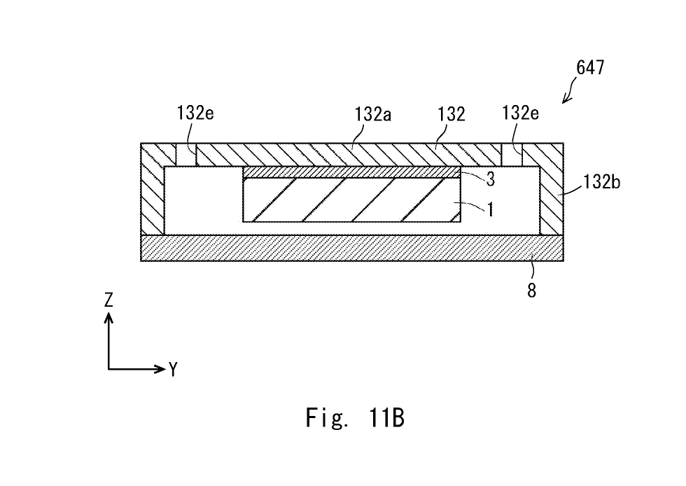

Next, there will be explained a modified example 5 of the piezoelectric vibration unit 207 of the piezoelectric speaker 200 according to the embodiment 2 with reference to FIGS. 11A and 11B. FIGS. 11A and 11B are cross-sectional views of the modified example 5 of the main portion of the piezoelectric speaker according to the embodiment 2.

As shown in FIG. 11A, there is a piezoelectric vibration unit 637 that is a modified example of the piezoelectric vibration unit 207. The piezoelectric vibration unit 637 has the same configuration as the piezoelectric vibration unit 237 (refer to FIG. 7C) except for having a metal vibration part 142. The piezoelectric vibration unit 637 includes the metal vibration part 142, and the metal vibration part 142 has the same configuration as the metal vibration part 42 (refer to FIG. 7C) except for having air holes 142e. The air holes 142e are installed in a body 142a, and are connected to a pressure adjusting unit (illustration is omitted). The pressure adjusting unit is, for example, a compressor. In the metal vibration part 142, pressure adjusting gas is supplied or discharged through the air holes 142e, and thereby a pressure of an inner space of the metal vibration part 142 is kept constant.

Since in the piezoelectric vibration unit 637, the body 142a, holding parts 142b, and a bottom 142c are integrated with each other, and the pressure of the inner space is kept constant, the piezoelectric vibration unit 637 further suppresses water and foreign substances having entered from the frequency adjusting hole 22b etc. from coming into contact with the piezoelectric element 1. In addition, since in the piezoelectric vibration unit 637, the body 142a, the holding parts 142b, and the bottom 142c are integrated with each other, the piezoelectric vibration unit 637 has a high rigidity.

Meanwhile, as shown in FIG. 11B, there is a piezoelectric vibration unit 647 that is a modified example of the piezoelectric vibration unit 207. The piezoelectric vibration unit 647 has the same configuration as the piezoelectric vibration unit 247 (refer to FIG. 7D) except for a metal diaphragm 132. The piezoelectric vibration unit 647 includes the metal diaphragm 132, and the metal diaphragm 132 has the same configuration as the metal diaphragm 32 (refer to FIG. 7D) except for having air holes 132e. The air holes 132e are installed in a body 132a, and are connected to a pressure adjusting unit (illustration is omitted). The pressure adjusting unit is, for example, a compressor. In the metal diaphragm 132, pressure adjusting gas is supplied or discharged through the air holes 132e, and thereby a pressure of an inner space of the metal diaphragm 132 is kept constant.

Since the piezoelectric vibration unit 647 has the metal diaphragm 132 and the bottom plate 8, and keeps constant the pressure of the inner space, it further suppresses the water and the foreign substances having entered from the frequency adjusting hole 22b etc. from coming into contact with the piezoelectric element 1. In addition, since the piezoelectric vibration unit 647 has the bottom plate 8, it has a higher rigidity compared with the piezoelectric vibration unit 227 (refer to FIG. 7B).

### Embodiment 3

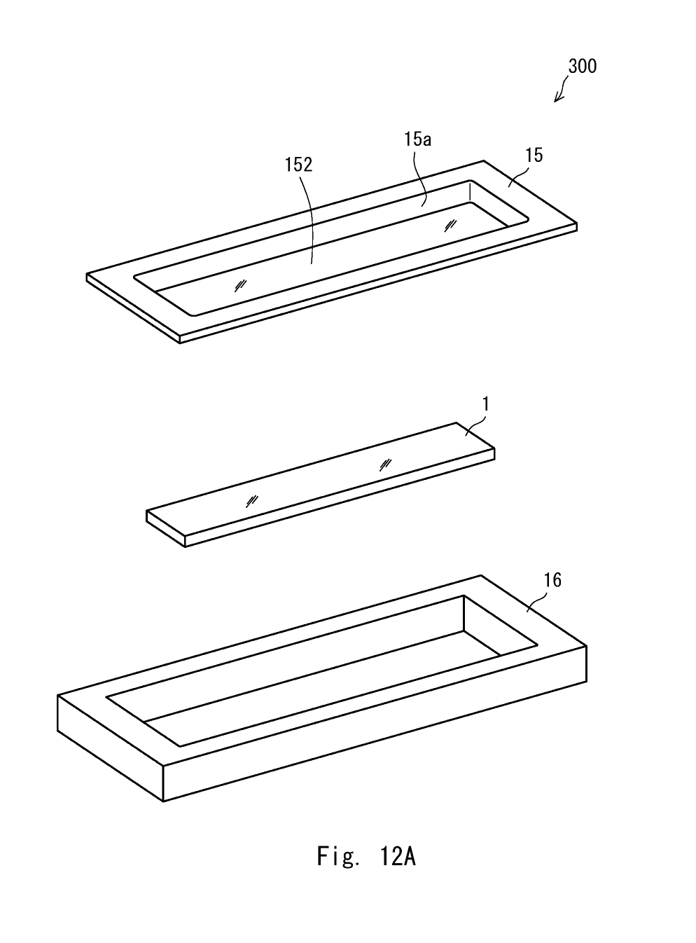

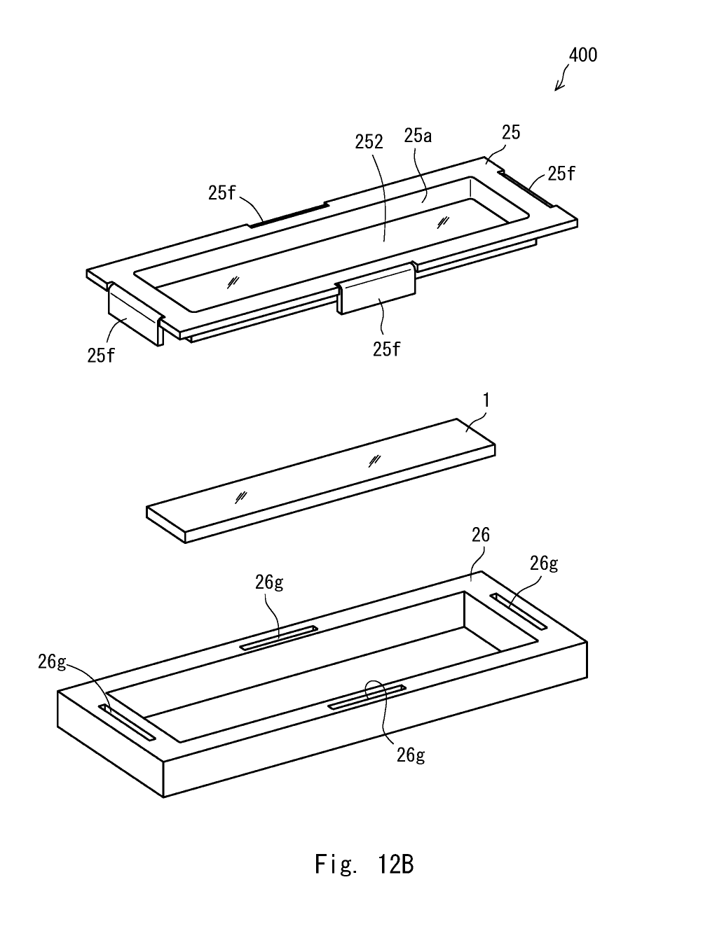

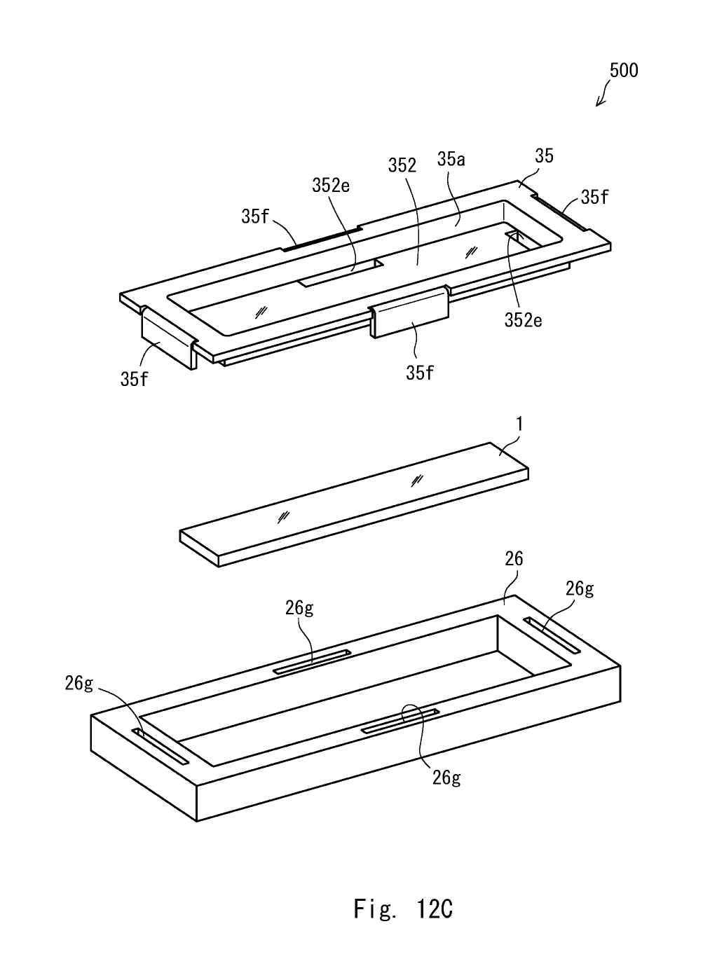

Next, a piezoelectric speaker according to an embodiment 3 will be explained with reference to FIG. 12A. FIG. 12A is an exploded perspective view of a modified example of the piezoelectric speaker according to the embodiment 3. The piezoelectric speaker according to the embodiment 3 has the same configuration as the piezoelectric speaker 100 according to the embodiment 1, except for the metal diaphragm 2 (refer to FIG. 2), the adhesive part 4, and the cover 5.

As shown in FIG. 12A, a piezoelectric speaker 300 includes: a metal diaphragm 152; a cover 15; and a case 16. The metal diaphragm 152 has the same configuration as the metal diaphragm 2 (refer to FIG. 2) except for being integrated with the cover 15. The cover 15 has the same configuration as the cover 5 (refer to FIG. 2) except for being integrated with the metal diaphragm 152. The integrated cover 15 and metal diaphragm 152, for example, can be obtained by raising of one plate material. Accordingly, since the cover 15 and the metal diaphragm 152 can be integrally manufactured by performing one processing of an integrated material, material cost and processing cost can be reduced. Note that unlike the piezoelectric speaker 100 (refer to FIG. 2), the piezoelectric speaker 300 does not include the adhesive part 4. The case 16 is an oblong frame-shaped body. Note that the piezoelectric speaker 300 may include the case 6 (refer to FIG. 2) instead of the case 16.

Hereinbefore, according to the piezoelectric speaker according to the embodiment 3, a cover and a metal diaphragm are integrated with each other, whereby material cost and processing cost can be reduced omitting an adhesive part, and thereby the piezoelectric speaker can be manufactured at low cost.

### Modified Example

Next, there will be explained modified examples of the piezoelectric speaker 300 according to the embodiment 3. FIGS. 12B and 12C are exploded perspective views of the modified examples of the piezoelectric speaker according to the embodiment 3.

As shown in FIG. 12B, there is a piezoelectric speaker 400 that is the modified example of the piezoelectric speaker 300. The piezoelectric speaker 400 has the same configuration as the piezoelectric speaker 300 except for a cover and a case. A cover 25 has the same configuration as the cover 15 except for including locking pieces 25f. A case 26 has the same configuration as the case 16 except for including locking holes 26g. The cover 25 includes the locking pieces 25f, and the case 26 includes the locking holes 26g. The locking pieces 25f are installed at places corresponding to a vicinity of an outer edge of the cover 25, specifically, a vicinity of a center of each side of a shape of the cover 25, i.e. a rectangle. The locking pieces 25f extend toward the case 16 side. The locking pieces 25f are, for example, formed using press working after the metal diaphragm 252 is formed using raising. The locking holes 26g are provided so as to correspond to the locking pieces 25f in a contact surface of the cover 25 that comes into contact with the case 26. The locking pieces 25f are inserted into the locking holes 26g, thereby the locking pieces 25f and the locking holes 26g are locked to each other, and the cover 25 is fixed to the case 26.

As shown in FIG. 12C, there is a piezoelectric speaker 500 that is the modified example of the piezoelectric speaker 300. The piezoelectric speaker 500 has the same configuration as the piezoelectric speaker 400 (refer to FIG. 12B) except for a metal diaphragm. A metal diaphragm 352 has the same configuration as the metal diaphragm 252 except for including frequency adjusting holes 352e. The metal diaphragm 352 includes the frequency adjusting holes 352e. The frequency adjusting holes 352e are installed at places corresponding to locking pieces 35f. In other words, the frequency adjusting holes 352e are installed at the places corresponding to a vicinity of an outer edge of the metal diaphragm 352, specifically, a vicinity of a center of each side of a shape of a cover 35, i.e. a rectangle. An effective length and a width of the metal diaphragm 352 are changed by changing the number, positions, and a size of the frequency adjusting holes 352e, and thereby a frequency can be adjusted.

### EXAMPLES

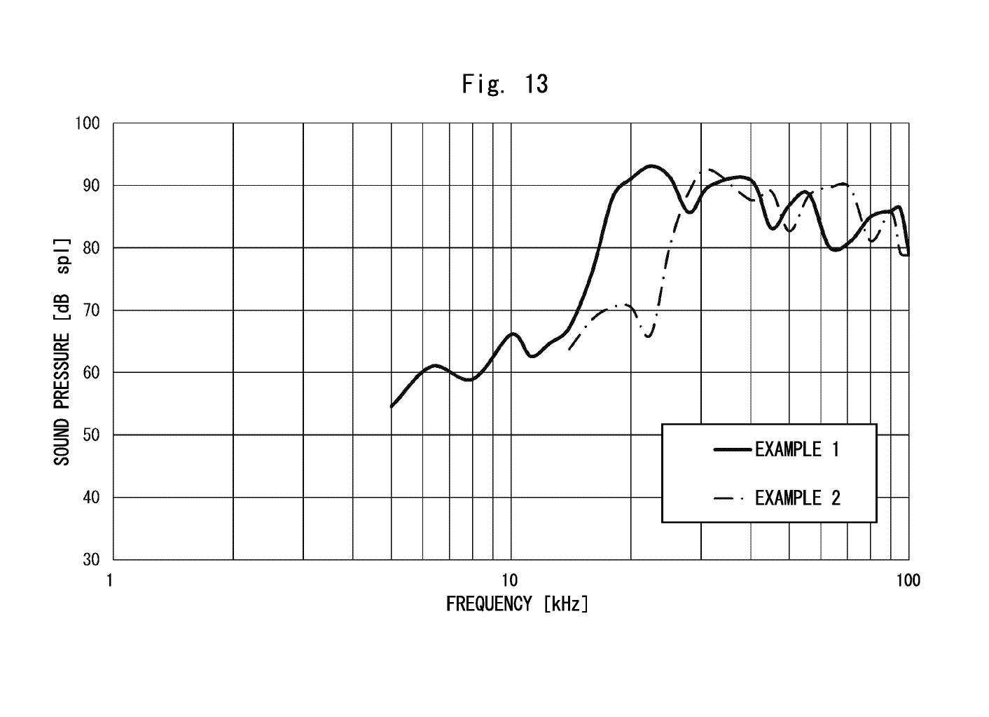

Next, Examples 1 and 2 of the piezoelectric speaker according to the embodiment 1 will be explained using FIG. 13. FIG. 13 is a graph showing a sound pressure with respect to a frequency of the Example of the piezoelectric speaker according to the embodiment 1.

In the Examples 1 and 2, there was used a piezoelectric speaker having the same configuration as the piezoelectric speaker 100 according to the embodiment 1. Specifically, in the Examples 1 and 2, additionally, a plate including brass and having a thickness of 1 mm was used as the metal diaphragm 2 (refer to FIG. 2). In addition, in the Example 1, a double-sided tape was used as the adhesive part 4 (refer to FIG. 2), and in the Example 2, an epoxy resin body formed by curing an epoxy resin agent was used as the adhesive part 4 (refer to FIG. 2). The double-sided tape used in the Example 1 is a band-shaped base material having a predetermined elastic modulus, an adhesive is applied to both-side principal surfaces of the base material, and thus the principal surfaces have an adhesive property.

In addition, the base material has a lower elastic coefficient compared with epoxy resin.

Sound was reproduced at 2 Vpp (peak to peak), and a sound pressure with respect to a frequency was measured in the Examples 1 and 2. The results were shown in FIG. 13.

As shown in FIG. 13, in the Example 1, the sound pressure reaches a maximum value in a frequency domain of 20 to 30 kHz. A sound pressure characteristic curve of the Example 1 falls within a predetermined range of approximately 79 to 93 dB sq1 in a frequency domain of 20 to 100 kHz. That is, in the Example 1, sound can be reproduced with stable sound pressures in the frequency domain of 20 to 100 kHz.

In addition, in the Example 2, the sound pressure reaches a maximum value in a frequency domain of approximately 30 kHz. In the Example 1, rise of the sound pressure tends to be earlier compared with the Example 2. It is considered that this is because the double-sided tape used as an adhesive part in the Example 1 is harder compared with the epoxy resin body formed by curing the epoxy resin.

A sound pressure characteristic curve of the Example 2 falls within the predetermined range of approximately 79 to 93 dB sq1 in a frequency domain of approximately 25 to 100 kHz. That is, also in the Example 2, sound can be reproduced with stable sound pressures in the frequency domain of 20 to 100 kHz.

Note that there is also considered an Example using a silicon resin body formed by curing a silicon adhesive as the adhesive part 4 (refer to FIG. 2). In this Example, it is expected that a sound pressure characteristic curve similar to those of the Examples 1 and 2 is obtained.

By the way, human beings are supposed to be unable to hear sound of a frequency higher than 20 kHz. Therefore, it is considered that such reproduction of the sound of the high frequency does not seemingly contribute to increase in quality of sound output by a speaker. However, sound of a fine signal can also be reproduced by reproducing the sound of the high frequency. Hereby, such reproduction of the sound of the high frequency can contribute to the increase in quality of the sound output by the speaker.

### Embodiment 4

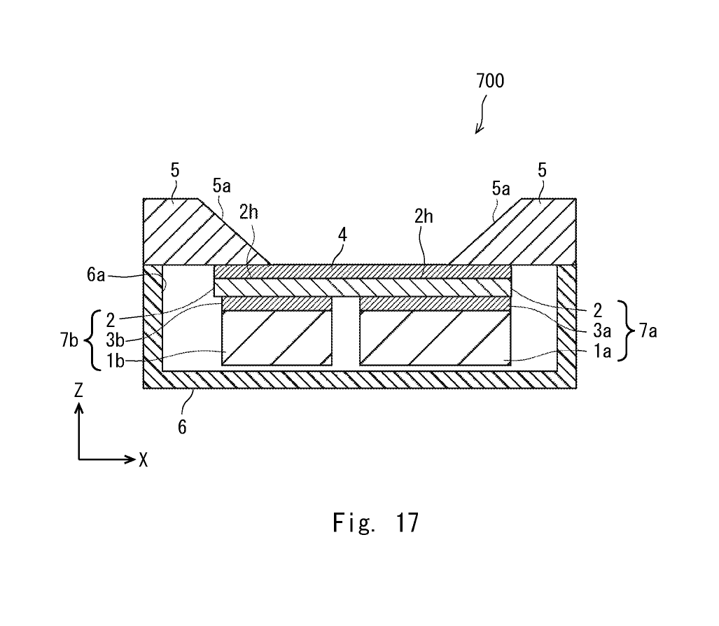

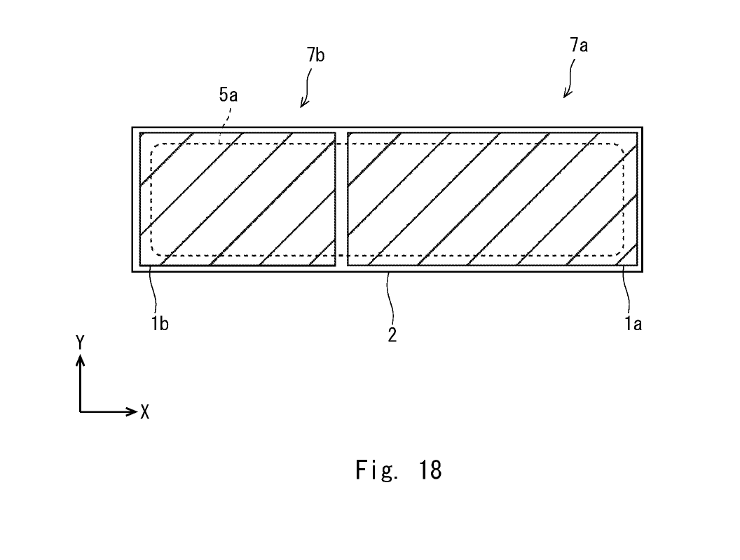

A speaker unit 700 according to the embodiment will be explained using FIGS. 17 and 18. FIG. 17 is an XZ cross-sectional view showing a configuration of the speaker unit 700. FIG. 18 is a bottom view showing a configuration of a main portion of the speaker unit 700. In the embodiment, two piezoelectric vibration units 7a and 7b are arranged in the case 6. Note that since basic configurations other than the two piezoelectric vibration units 7a and 7b are similar to those of the speaker units 100, 200, 300, 400, and 500 of the above-described embodiments, explanation thereof is appropriately omitted. For example, there can be used the case 6, the adhesive part 3, the metal diaphragm 2, etc. that have similar configurations shown in FIGS. 1 and 3.

The piezoelectric vibration units 7a and 7b are housed in the case 6. The piezoelectric vibration unit 7a has: a piezoelectric element 1a; an adhesive part 3a; and the metal diaphragm 2. Similarly to the embodiment 1, the piezoelectric element 1a is made to adhere to the metal diaphragm 2 through the adhesive part 3a. The piezoelectric vibration unit 7b has: a piezoelectric element 1b; an adhesive part 3b; and the metal diaphragm 2. Similarly to the embodiment 1, the piezoelectric element 1b is made to adhere to the metal diaphragm 2 through the adhesive part 3b.

The metal diaphragm 2 is in common in the two piezoelectric vibration units 7a and 7b. That is to say, the metal diaphragm 2 has one metal plate, and the piezoelectric elements 1a and 1b are attached to the one metal plate. The piezoelectric elements 1a and 1b are attached to the same surface of the metal diaphragm 2. Specifically, the piezoelectric elements 1a and 1b are attached to a surface of the metal diaphragm 2 on an opposite side of the sound emitting hole 5a side. When a voltage is supplied to the piezoelectric elements 1a and 1b, the piezoelectric elements 1a and 1b are distorted. Hereby, the metal diaphragm 2 vibrates, and sound is generated from the sound emitting hole 5a.

The two piezoelectric elements 1a and 1b are arranged side by side in an X direction. That is to say, the piezoelectric element 1a is arranged on a +X side of the piezoelectric element 1b. The piezoelectric elements 1a and 1b overlap with the sound emitting hole 5a in an XY planar view. Further, parts of the piezoelectric elements 1a and 1b protrude from the sound emitting hole 5a. The piezoelectric elements 1a and 1b each have a substantially rectangular shape in the XY planar view.

The two piezoelectric elements 1a and 1b have different sizes in the XY planar view. Specifically, the two piezoelectric elements 1a and 1b have different widths in the X direction. Note that the two piezoelectric elements 1a and 1b have the same width in a Y direction. The two piezoelectric elements 1a and 1b differ in frequency of natural vibration modes. That is to say, a resonance frequency of the piezoelectric element 1a is different from that of the piezoelectric element 1b. In addition, the frequencies of the natural vibration modes of the piezoelectric elements 1a and 1b are different from the frequency of the natural vibration mode of the metal diaphragm 2.

In the embodiment, the two piezoelectric elements 1a and 1b having the different resonance frequencies are connected to the metal diaphragm 2 through the adhesive parts 3a and 3b. In doing so, a high sound pressure and a high SN ratio can be obtained also in a high frequency domain of 5 to 50 kHz. Accordingly, a high-performance speaker unit can be realized with simple structure. In the high frequency domain, while the SN ratio in a general electromagnetic speaker is 45 dB, the SN ratio of 60 dB can be achieved in the piezoelectric speaker unit 700.

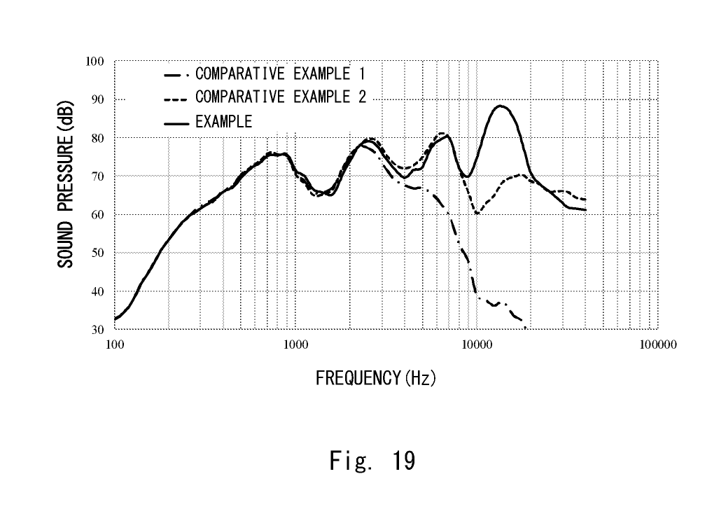

Frequency characteristics of a sound pressure of the piezoelectric speaker unit 700 are shown in FIG. 19. In FIG. 19, the frequency characteristics of the sound pressure of the piezoelectric speaker unit 700 are shown as an Example. In addition, in FIG. 19, frequency characteristics in a case of using a dynamic speaker (an electromagnetic speaker) and an LPF (Low Pass Filter) are shown as a comparative example 1, and frequency characteristics of a piezoelectric speaker unit having one piezoelectric element are shown as a comparative example 2. Compared with the comparative examples 1 and 2, the piezoelectric speaker unit 700 can obtain a high sound pressure also in a high frequency domain of not less than 5 kHz.

The piezoelectric elements 1a and 1b having different dimensions from each other differ in resonance frequency. Additionally, flatness of the sound pressure frequency characteristics can be optimized by a combination of respective shapes of the rectangular piezoelectric elements 1a and 1b and the metal diaphragm 2. Note that although the two piezoelectric elements 1a and 1b are provided in the above explanation, three or more piezoelectric elements can be provided. That is to say, a plurality of piezoelectric elements 1 may just be made to adhere to the metal diaphragm 2 through the adhesive part 3.

A frequency domain in which the mode of the metal diaphragm 2 does not rise is preferably matched with the resonance frequencies of the piezoelectric elements 1a and 1b. Further, the resonance frequency Qm of the piezoelectric element is preferably set in a range of 1.0 to 5.0 by using an elastic body for the adhesive part 3. Hereby, sound can be reproduced in a wide frequency band, and with a flat sound pressure characteristic curve.

### Embodiment 5

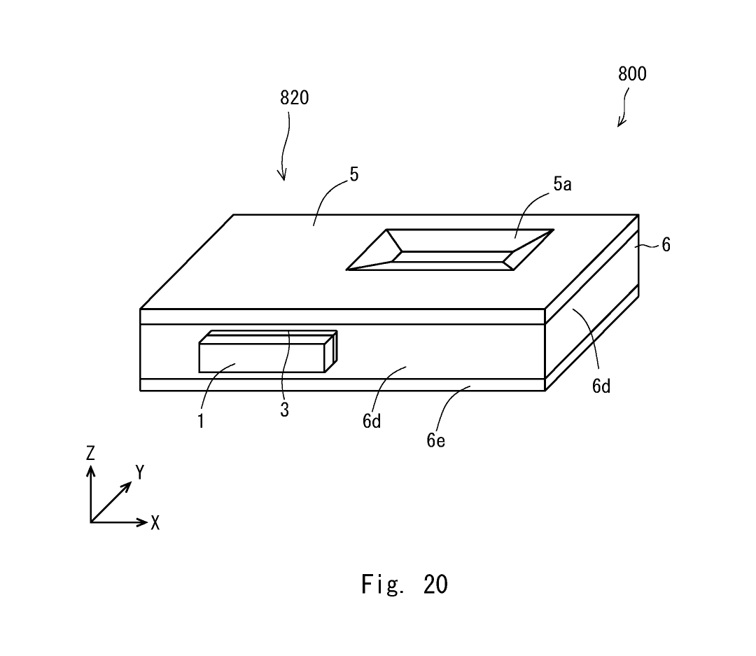

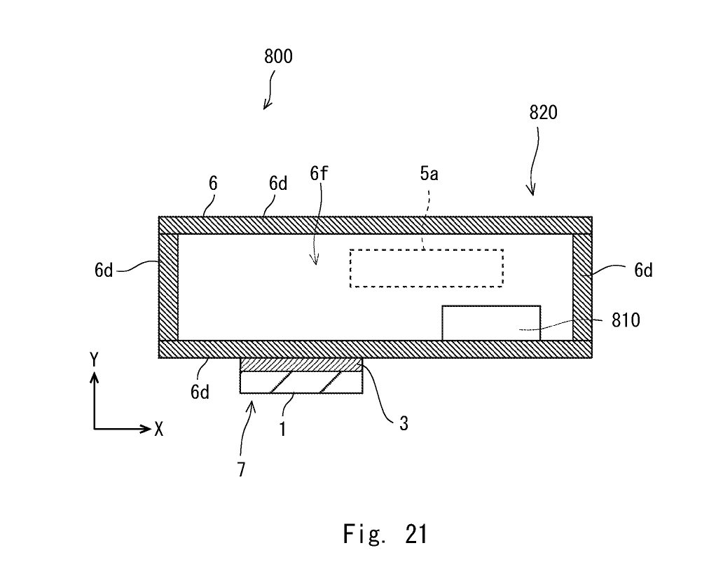

A piezoelectric speaker unit 800 according to the embodiment will be explained using FIGS. 20 and 21. FIG. 20 is a perspective view showing an appearance of the piezoelectric speaker unit 800. FIG. 21 is an XY plan view showing a configuration in an internal space of a housing 820 of the piezoelectric speaker unit 800. In the embodiment, an electromagnetic speaker 810 is provided inside the case 6 of FIG. 21. In addition, the piezoelectric element 1 is provided outside the case 6. Note that explanation of configurations similar to the above-described embodiments 1 to 4 is appropriately omitted.

The housing 820 has a box shape. For example, the housing 820 has the case 6 and the cover 5. The case 6 includes side plates 6d and a back plate 6e. The back plate 6e is opposed to the cover 5. The cover 5 and the back plate 6e are flat plates parallel to each other. The cover 5, the side plates 6d, and the back plate 6e are preferably rectangular metal plates, respectively. Further, the cover 5 has the sound emitting hole 5a. A cross-sectional shape of the sound emitting hole 5a is a tapered shape that becomes larger toward an outside similarly to the configuration shown in FIG. 2.

Note that the embodiment is explained assuming as a front side a side on which the sound emitting hole 5a is provided. The back plate 6e is arranged to be opposed to the cover 5. The side plates 6d are arranged between the cover 5 and the back plate 6e. That is to say, the side plates 6d connect the cover 5 and the back plate 6e. Here, since outer shapes of the cover 5 and the back plate 6e are substantially rectangular shapes in the XY planar view, the case 6 has the four side plates 6d. That is to say, the side plates 6d are arranged at each end side of the substantially rectangular cover 5 and back plate 6e, respectively. The opposed two side plates 6d are in parallel to each other. The adjacent two side plates 6d are perpendicular to each other.

Assume the internal space of the housing 820 as an air chamber 6f. That is to say, the space defined by the cover 5, the back plate 6e, and the side plates 6d serves as the air chamber 6f. Specifically, the rectangular parallelepiped space surrounded by the cover 5, the back plate 6e, and the four side plates 6d serves as the air chamber 6f. The air chamber 6f is communicated with an outer space through the sound emitting hole 5. The cover 5 and the back plate 6e are arranged to be opposed to each other through the air chamber 6f. Accordingly, the cover 5 serves as a front plate for defining the air chamber 6f.

Note that parts or all of the cover 5, the back plate 6e, and the side plates 6d may be integrally formed. For example, the back plate 6e and the side plates 6d may be integrally formed similarly to the case 6 shown in the embodiment 1. Additionally, the cover 5 may be removable as the cover 5 of the Embodiment 1. As a matter of course, components other than the cover 5 may be removable.

The electromagnetic speaker 810 is arranged in the air chamber 6f. The electromagnetic speaker 801 is attached to the one side plate 6d in FIG. 21. Specifically, the electromagnetic speaker 810 is installed on a surface (hereinafter referred to as an inner surface) of the air chamber 6f side of the side plate 6d of a −Y side. The electromagnetic speaker 810 has: a diaphragm; a voice coil; a permanent magnet; etc. The voice coil and the diaphragm vibrate by supplying a current to the voice coil. Hereby, the electromagnetic speaker 810 generates sound. Here, the electromagnetic speaker 810 generates the sound toward the sound emitting hole 5a.

The piezoelectric element 1 is provided outside the case 6. The piezoelectric element 1 is made to adhere to the side plate 6d of the case 6 through the adhesive part 3. The adhesive part 3 is an elastic body similarly to the above. Here, the piezoelectric element 1 is attached to a surface (hereinafter referred to as an outer surface) of the side plate 6d on an opposite side of the air chamber 6f side. The inner surface of the one side plate 6d serves as a mounting surface of the electromagnetic speaker 810, and the outer surface thereof serves as a mounting surface of the piezoelectric element 1. As described above, the piezoelectric element 1 is arranged on the one surface (the outer surface) of the opposed two surfaces of the side plate 6d, and the electromagnetic speaker 810 is arranged on the other surface (the inner surface) thereof. In other words, the mounting surface of the piezoelectric element 1 and the mounting surface of the electromagnetic speaker 801 serve as opposed surfaces of the case 6.

The electromagnetic speaker 810 is fixed to the case 6 in the piezoelectric speaker unit 800 according to the embodiment. Both the electromagnetic speaker 810 and the piezoelectric element 1 mounted at the case 6 vibrate. A frequency of a natural vibration mode of the electromagnetic speaker 810 and the frequency of the natural vibration mode of the piezoelectric element 1 are different from each other. Accordingly, a high sound pressure and a high SN ratio can be realized also in a high frequency region. Sound reproduction in a wide band of 100 Hz to 100 kHz can be made by the configuration of the embodiment.

The side plate 6d serving as the mounting surface on which the piezoelectric element 1 is mounted is preferably formed of a metal plate. That is to say, the side plates 6d, the adhesive part 3, and the piezoelectric element 1 are included in the piezoelectric vibration unit 7. In doing so, the side plate 6d functions as the metal vibration part 2 of the embodiment 1 etc. Consequently, the high sound pressure and the high SN ratio can be realized in the high frequency region similarly to the embodiment 1. Note that the piezoelectric vibration unit 7 does not close the sound emitting hole 5a in the embodiment.

Note that the side plate 6d serving as the mounting surface on which the piezoelectric element 1 is mounted is preferably formed of a metal plate having a thickness of 10 to 300 μm. In doing so, a higher sound pressure and a higher SN ratio can be realized also in the high frequency region.

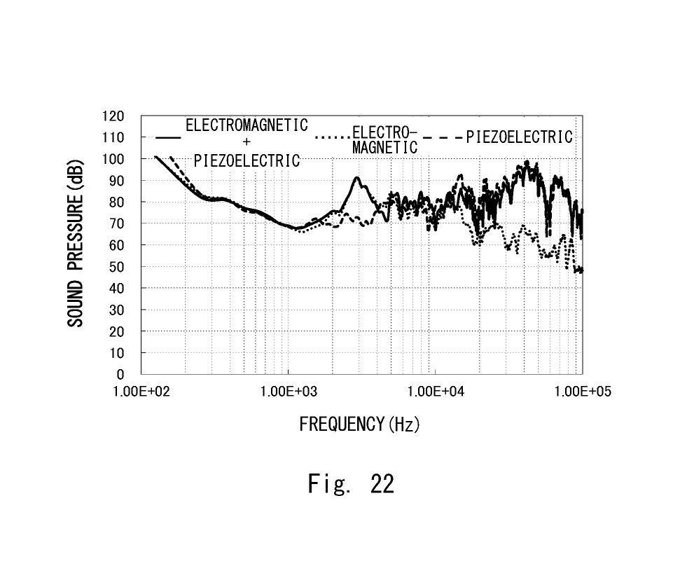

FIG. 22 is a graph showing frequency characteristics of a sound pressure of the piezoelectric speaker unit 800 according to the embodiment. In FIG. 22, the sound pressure frequency characteristics in a configuration in which only the electromagnetic speaker 810 is mounted are shown as “electromagnetic”. The sound pressure frequency characteristics in a configuration in which only the piezoelectric element 1 is mounted are shown as “piezoelectric”. The sound pressure frequency characteristics of the electromagnetic speaker 810 in which both the piezoelectric element 1 and the electromagnetic speaker 810 are mounted are shown as “electromagnetic+piezoelectric”. As shown in FIG. 22, in a case where both the piezoelectric element 1 and the electromagnetic speaker 810 are mounted, reproduction with a high sound pressure can be made also in a frequency of not less than 20 kHz. A high sound pressure and a high SN ratio can be realized also in a high frequency region by the configuration of the embodiment.

### Modified Example 6

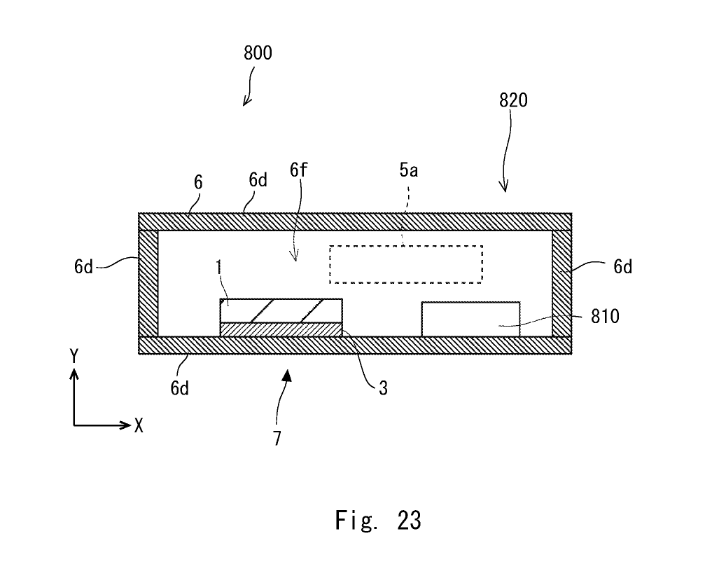

A modified example 6 of the embodiment 5 will be explained using FIG. 23. FIG. 23 is an XY cross-sectional view showing a main portion of the piezoelectric speaker unit 800 according to the modified example 6. In the modified example 6, a position of the piezoelectric element 1 is different from the configuration of the embodiment 5. Specifically, the piezoelectric element 1 is arranged in the housing 820. Note that since a basic configuration of the piezoelectric speaker unit 800 is the same as the above, explanation thereof is appropriately omitted.

In the embodiment, the piezoelectric element 1 is arranged in the air chamber 6f. That is to say, the piezoelectric element 1 is attached to the inner surface of the side plate 6d through the adhesive part 3. In the embodiment, the inner surface of the side plate 6d of the −Y side serves as the mounting surface of the piezoelectric element 1. Accordingly, the electromagnetic speaker 810 and the piezoelectric element 1 are installed on the same surface (the inner surface) of the side plate 6d. The mounting surface of the piezoelectric element 1 and the mounting surface of the electromagnetic speaker 801 are the same surface of the case 6.

Also in the modified example 6, both the electromagnetic speaker 810 and the piezoelectric element 1 mounted in the case 6 vibrate. The frequency of the natural vibration mode of the electromagnetic speaker 810 and the frequency of the natural vibration mode of the piezoelectric element 1 are different from each other. Further, in the modified example 6, vibrations of the electromagnetic speaker 810 and the piezoelectric element 1 are mixed in the air chamber 6f and subsequently, the mixed vibrations are emitted from the sound emitting hole 5a. Accordingly, a high sound pressure and a high SN ratio can be realized also in a high frequency region. Sound reproduction in the wide band of 100 Hz to 100 kHz can be made by the configuration of the embodiment.

The side plate 6d serving as the mounting surface on which the piezoelectric element 1 is mounted is preferably formed of a metal plate. That is to say, the side plates 6d, the adhesive part 3, and the piezoelectric element 1 are included in the piezoelectric vibration unit 7. In doing so, the high sound pressure and the high SN ratio can be realized in the high frequency region similarly to the embodiment 1.

Note that the side plate 6d serving as the mounting surface on which the piezoelectric element 1 is mounted is preferably formed of a metal plate having a thickness of 10 to 300 μm. In doing so, a higher sound pressure and a higher SN ratio can be realized in the high frequency region.

### Modified Example 7

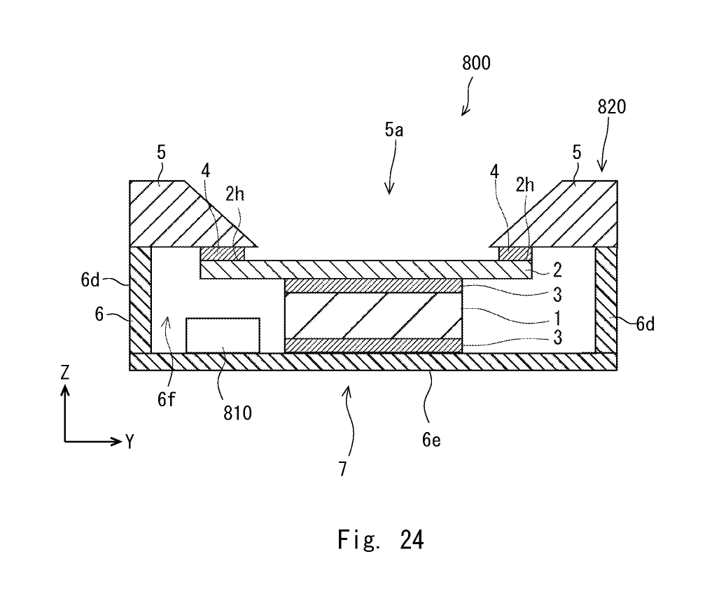

A modified example 7 of the embodiment 5 will be explained using FIG. 24. FIG. 24 is a YZ cross-sectional view showing a main portion of the piezoelectric speaker unit 800 according to the modified example 7. In the modified example 7, positions of the piezoelectric element 1 and the electromagnetic speaker 810 are different from the configuration of the embodiment 5. Note that since the basic configuration of the piezoelectric speaker unit 800 is the same as the above, explanation thereof is appropriately omitted.

As shown in FIG. 23, the electromagnetic speaker 810 is attached to the back plate 6e. Specifically, the electromagnetic speaker 810 is fixed to an inner surface of the back plate 6e. Accordingly, the electromagnetic speaker 810 is arranged in the air chamber 6f. The electromagnetic speaker 810 generates sound toward the sound emitting hole 5a.

The piezoelectric element 1 is made to adhere to the back plate 6e and the cover 5. Specifically, the adhesive part 3 including an elastic body is provided on both surfaces of the piezoelectric element 1. A back surface of the piezoelectric element 1 is made to adhere to the back plate 6e through the adhesive part 3. The back plate 6e serving as the mounting surface of the piezoelectric element 1 is preferably a metal plate having a thickness of 10 to 300 μm. A front surface of the piezoelectric element 1 is made to adhere to the metal diaphragm 2 through the adhesive part 3.

The adhesive part 4 is provided on a front surface of the metal diaphragm 2. Additionally, the metal diaphragm 2 is made to adhere to the cover 5 through the adhesive part 4. The adhesive part 4 is attached to the outer edge 2h of the metal diaphragm 2. Accordingly, when the piezoelectric speaker 100 is seen from the cover 5 side, the outer edge 2h is covered with the cover 5. In addition, the adhesive part 4 is provided except for a portion corresponding to the sound emitting hole 5a of the cover 5. Accordingly, when the piezoelectric speaker 100 is seen from the cover 5 side, the metal diaphragm 2 can be seen from the sound emitting hole 5a. The metal diaphragm 2 serving as the mounting surface of the piezoelectric element 1 is preferably a metal plate having a thickness of 10 to 300 μm.

As described above, in the modified example 7, the adhesive part 3 is provided on the front surface and the back surface of the piezoelectric element 1. That is to say, the piezoelectric element 1 is sandwiched by the two adhesive parts 3. Additionally, both surfaces of the piezoelectric element 1 are fixed to the housing 820 through the adhesive parts 3. The back plate 6e, the adhesive part 3, the piezoelectric element 1, the adhesive part 3, and the metal diaphragm 2 are included in the piezoelectric vibration unit 7.

Also in the modified example 7, both the electromagnetic speaker 810 and the piezoelectric element 1 mounted in the case 6 vibrate. The frequency of the natural vibration mode of the electromagnetic speaker 810 and the frequency of the natural vibration mode of the piezoelectric element 1 are different from each other. Further, in the modified example, vibrations of the electromagnetic speaker 810 and the piezoelectric element 1 are mixed in the air chamber 6f and subsequently, the mixed vibrations are emitted from the sound emitting hole 5a. Sound reproduction in the wide band of 100 Hz to 100 kHz can be made by the configuration of the embodiment.

The metal diaphragm 2 serving as the mounting surface of the piezoelectric element 1 is fixed to the other member (the cover 5) through the adhesive part 4 that is an elastic body. Consequently, good characteristics can be obtained as in the above-described embodiments. In addition, a surface on which the metal diaphragm 2 is mounted is not limited to the cover 5. The metal plate (the metal vibration part 2) may be fixed to the side plate 6d or the back plate 6e through the adhesive part 3 that is the elastic body.

### Modified Example 8

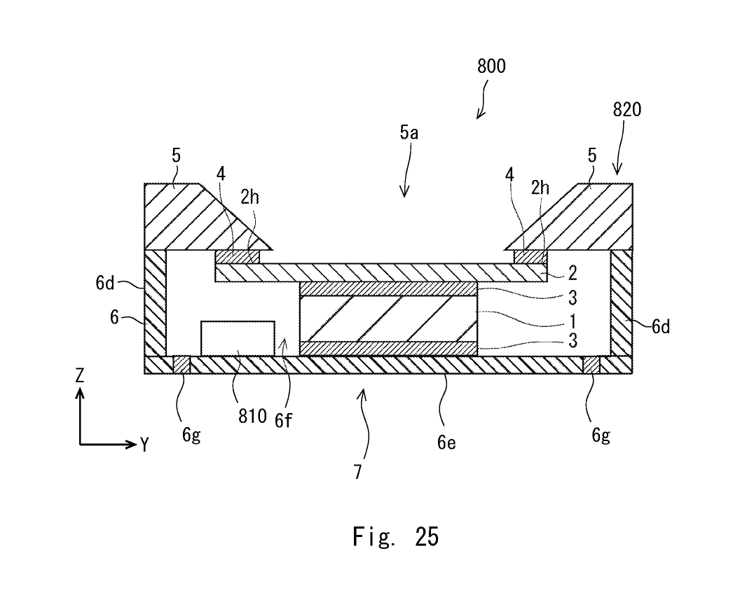

A modified example 8 of the embodiment 5 will be explained using FIG. 25. FIG. 25 is a YZ cross-sectional view showing a main portion of the piezoelectric speaker unit 800 according to the modified example 8. In the modified example 8, a configurations of the back plate 6e is different from the configuration of the modified example 7. Note that since the basic configuration of the piezoelectric speaker unit 800 is the same as the above, explanation thereof is appropriately omitted.

Although the back plate 6e is the metal plate in the modified example 7, some parts of the back plate 6e are resin 6g in the modified example 8. That is to say, the back plate 6e includes a metal material and a resin material. That is to say, some parts of the back plate 6e are formed of the resin material, and a remaining portion thereof is formed of the metal material. Consequently, since some of the back plate 6e serving as the mounting surface are formed of the resin 6g as described above, the back plate 6e is partially a metal plate. The side plate 6d, the cover 5, or the back plate 6e serves as the mounting surface of the piezoelectric element 1, the metal material and the resin material are included, and thereby good characteristics can be obtained.

Note that although in the embodiment 5, and the modified examples 6 to 8 thereof, the piezoelectric element 1 is fixed to the case 6 through the adhesive part 3 that is the elastic body, the piezoelectric element 1 may be fixed to the case 6 without the elastic body.

Although the side plate 6d is used for the mounting surface of the piezoelectric element 1 in the embodiment 5 and the modified example 6, and the back plate 6e is used therefor in the modified examples 7 and 8, the mounting surface of the piezoelectric element 1 is not particularly limited. Further, the piezoelectric element 1 may be attached to an outside surface of the housing 820.

In addition, the configuration of the embodiment 4 and the configuration of the embodiment 5 may be combined with each other. In this case, the electromagnetic speaker 810 is arranged inside the case 6, and the two or more piezoelectric elements 1 are mounted at the case 6.

The piezoelectric speakers according to the above-described embodiments 1 to 5 can be used incorporated in various apparatuses. For example, the above-described piezoelectric speakers can be used as a high frequency speaker that is incorporated in PCs (personal computers), tablet PCs, next-generation 4K televisions, next-generation 8K televisions, and in-vehicle and non-portable high-resolution audios.

Particularly, along with the expansion of digital sound, information on sound source sampling frequency in music reproduction, and the number of bits, there are growing needs for a speaker reproducible with a high sound pressure and a high SN ratio in a high frequency of 20 to 70 kHz. Although a high frequency of not less than 20 kHz is supposed to be inaudible to human beings, actually, even the high frequency being reproducible leads to even fine signals being reproducible. Increase in quality of a sound source enables to contribute to increase in quality of a speaker output. Note that in the above explanation, the embodiments are explained, omitting wires etc. that are connected to the piezoelectric element and the electromagnetic speaker.

Hereinbefore, although the present invention has been explained in the context of the above-described embodiments and Examples, it is not limited only to the configurations of the above-described embodiments and Examples. It is needless to say that the present invention includes various deformations, modifications, and combinations that can be made by those skilled in the art within the scope of the invention of claims of CLAIMS in the present application.

This application claims priority based on Japanese Patent Application No. 2015-24041 filed on Feb. 10, 2015, and Japanese Patent Application No. 2015-106550 filed on May 26, 2015, and the entire disclosure thereof is incorporated herein.

### REFERENCE SIGNS LIST

100, 200, 300, 400, and 500 piezoelectric speaker
7, 207, 217, 227, 237, 247, 317, 327, 337, 347, 417, 427, 437, 447, 517, 527, 537, 547, 637, and
647 piezoelectric vibration unit
1 piezoelectric element
2, 22, 32, 42, 52, 62, 72, 82, 102, 112, 132, 142, 152, 252, and 352 metal diaphragm (metal vibration part)
12a, 32a, 42a, 72a, 82a, 102a, and 132a body
3 adhesive part

1. A piezoelectric speaker comprising:
a piezoelectric element; and
a metal vibration part to which the piezoelectric element is made to adhere through an adhesive part, wherein
the piezoelectric element is a substantially rectangular plate,
the metal vibration part includes a substantially rectangular plate-shaped part that is vibrated by the piezoelectric element, and
a frequency of a natural vibration mode of the piezoelectric element and a frequency of a natural vibration mode of the metal vibration part are set to be different from each other.

2. The piezoelectric speaker according to claim 1, wherein a relation between an area Ap of the piezoelectric element and an area Am of the rectangular plate-shaped part of the metal vibration part satisfies 1.1≦Am/Ap≦10.

3. The piezoelectric speaker according to claim 1, wherein the adhesive part is an elastic body.

4. The piezoelectric speaker according to claim 3, wherein a mechanical quality factor Qm of a vibrating body in which the piezoelectric element and the adhesive part are integrated with each other satisfies Qm≦5.0.

5. The piezoelectric speaker according to claim 1, further comprising a case at which the metal vibration part is provided, the case including a sound emitting hole,
wherein the sound emitting hole has a horn shape.

6. The piezoelectric speaker according to claim 1, wherein the rectangular plate-shaped part includes a frequency adjusting hole.

7. The piezoelectric speaker according to claim 1, further comprising a case,
wherein the metal vibration part is made to adhere to the case through an elastic body.

8. The piezoelectric speaker according to claim 1, wherein a plurality of the piezoelectric elements are made to adhere to the metal vibration part through the adhesive part.

9. The piezoelectric speaker according to claim 8, wherein frequencies of natural vibration modes of the plurality of piezoelectric elements are different from each other.

10. The piezoelectric speaker according to claim 8, wherein
the metal vibration part includes one metal plate, and
the plurality of piezoelectric elements are made to adhere to the metal plate through the adhesive part.

11. The piezoelectric speaker according to claim 10, wherein the plurality of piezoelectric elements are attached to the same surface of the metal plate.

12. A piezoelectric speaker according to claim 1, further comprising:
a case; and
an electromagnetic speaker arranged inside the case.

13. The piezoelectric speaker according to claim 12, wherein the piezoelectric element is arranged inside the case.

14. The piezoelectric speaker according to claim 13, wherein a mounting surface of the electromagnetic speaker and a mounting surface of the piezoelectric element are the same surface of the case.

15. The piezoelectric speaker according to claim 12, wherein
the piezoelectric element is arranged outside the case, and
a mounting surface of the electromagnetic speaker and a mounting surface of the piezoelectric element are opposed surfaces of the case.

16. The piezoelectric speaker according to claim 12, wherein the metal vibration part serves as a side plate or a back plate of the case.

17. The piezoelectric speaker according to claim 12, further comprising a cover that covers an opening of the case,
wherein the metal vibration part is fixed to the case or the cover through an elastic member.

18. The piezoelectric speaker according to claim 12, wherein the metal vibration part includes a metal plate having a thickness of 10 to 300 μm.

19. A piezoelectric speaker comprising:
a housing that includes a front plate including a sound emitting hole, a back plate opposed to the front plate, and side plates between the front plate and the back plate;
an electromagnetic speaker provided inside the housing; and
a piezoelectric element attached to the housing.

20. The piezoelectric speaker according to claim 19, wherein
the piezoelectric element is fixed to the housing through an adhesive part, and
the adhesive part is an elastic body.

21. The piezoelectric speaker according to claim 19, wherein the piezoelectric element is arranged inside the housing.

22. The piezoelectric speaker according to claim 21, wherein a mounting surface of the electromagnetic speaker and a mounting surface of the piezoelectric element are the same surface of the housing.

23. The piezoelectric speaker according to claim 19, wherein
the piezoelectric element is arranged outside the housing, and
a mounting surface of the electromagnetic speaker and a mounting surface of the piezoelectric element are opposed surfaces of the housing.

24. The piezoelectric speaker according to claim 19, wherein the mounting surface of the piezoelectric element is a metal plate.

25. The piezoelectric speaker according to claim 24, wherein the metal plate is fixed to the side plate, the front plate, or the back plate through an elastic member.

26. The piezoelectric speaker according to claim 24, wherein the metal plate has a thickness of 10 to 300 μm.

27. The piezoelectric speaker according to claim 19, wherein the side plate, the front plate, or the back plate serves as the mounting surface of the piezoelectric element, and includes a metal material and a resin material.
